(19) United States
(12) Patent Application Publication
(10) Pub. No.: US 2002/0176412 A1
(43) Pub. Date: Nov. 28, 2002

(54) Signaling free, self learning scatternet scheduling using checkpoints

(76) Inventors: Andras Racz, Budapest (HU); Gyorgy Miklos, Budapest (HU); Andras Valko, Budapest (HU); Ferenc Kubinszky, Szentendre (HU)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/840,241

(22) Filed: Apr. 24, 2001

(51) Int. Cl. H04L 12/56

(52) U.S. Cl. 370/389; 370/401

(57) ABSTRACT

A system and method of communicating between nodes in an ad hoc polling based communication infrastructure such as a Bluetooth system. Frames on a link between two nodes are designated as checkpoint frames on which each of the two nodes checks for presence of the other. Based upon factors such as attendance or absence of the checkpoint frames and usage of the link, one or the other node can adjust the node checking intensity and the other node follows suit in accordance with predefined rules. The checkpoint frames can either be periodic or pseudo random.

### BACKGROUND

The present invention pertains to a method and system for the wireless communication of data and voice between devices via a radio link. One method of achieving this is through the use of Bluetooth, an open specification for wireless communication. Bluetooth is a wireless personal area network (PAN) technology for short-range transmission of digital voice and data between mobile devices (e.g., laptops, PDAs, phones) and desktop devices. Bluetooth supports point-to-point and multipoint applications and is described in further detail in the Bluetooth Baseband Specification 1.1 by the Bluetooth Special Interest Group (SIG), which in expressly incorporated by reference in its entirety. Of a historical note, the name “Bluetooth” is derived from the 10th century King of Denmark, Harald Blåtand, alias Bluetooth, who introduced Christianity to Denmark.

The emergence of Bluetooth as a default radio interface in various types of devices provides an opportunity to turn them from stand-alone tools into networked equipment. Bluetooth offers a number of advantages over conventional wireless technologies. For example, unlike conventional infrared data transmission techniques which require line-of-sight between devices, Bluetooth uses omnidirectional radio waves that can transmit through walls and other non-metal barriers. To counteract interference from outside sources or from other devices, Bluetooth units utilize a frequency hopping scheme and also have the ability to change coding scheme in response to changes in interference. That is, when the interference becomes worse a more protective coding scheme is selected, which tends to reduce the useful transmission rate. However, in addition to the advantages Bluetooth has to offer, there are also a number of new challenges associated with the Bluetooth technology, partly stemming from the fact that Bluetooth was originally developed for single hop wireless connections.

Bluetooth systems, in accordance with the Bluetooth Baseband Specification 1.1, use short range radio technology operating in the unlicensed 2.4 GHz Industrial-Scientific-Medical (ISM) band using a frequency hopping scheme. The hopping is performed on 79 RF channels spaced 1 MHz apart using a frequency hopping spread spectrum technique that changes its frequency 1600 times per second. Bluetooth provides considerable data transfer capability at short ranges; e.g., up to 720 Kbps within 10 meters and up to 100 meters with a power boost. The Bluetooth system provides full-duplex transmission based on slotted Time Division Duplex (TDD) scheme, where each slot is 0.625 ms long.

FIG. 1 depicts an exemplary Bluetooth piconet. Bluetooth (BT) units are organized into “piconets” which are collections of devices connected in an ad hoc fashion. Bluetooth piconets are “ad hoc” in the sense that, unlike conventional networks, Bluetooth piconets are not fixed and the nodes are packet forwarding network elements that can serve as sources and destinations (e.g., hosts and routers) at the same time. A piconet is initially formed with two connected devices, herein referred to as “nodes”. One Bluetooth device in each piconet acts as the master, and can have any number of slaves, out of which up to seven can be active simultaneously. The piconet of FIG. 1 has one master node, BT 11, and one slave node, BT 12. A “master” is the device in a piconet whose clock and hopping sequence are used to sequence other devices in piconet. A “slave” is any other active device in the piconet. The terms “master” and “slave” are defined as logical states, in that a particular Bluetooth device can be a master or a slave. In fact, a Bluetooth unit can simultaneously be a master in one piconet and a slave in another piconet.

Each Bluetooth unit has a globally unique 48 bit IEEE 802 address. This address, called the Bluetooth Device Address (e.g., BD_ADDR) is initially assigned at the time the Bluetooth unit is manufactured. In addition, the Master of a piconet assigns a local active member address (e.g, AM_ADDR) to each active member of the piconet. The AM_ADDR, which is only three bits long, is dynamically assigned and deassigned whenever a new connection is established or released, respectively. The AM_ADDR is unique only within a single piconet. The master uses the AM_ADDR when polling a slave in a piconet. However, when the slave, triggered by a packet from the master addressed with the slave's AM_ADDR, transmits a packet to the master, it includes its own AM_ADDR (not the masters) in the packet header.

FIG. 2 illustrates a piconet with a master node and a plurality of slave nodes 22-28 arranged in a star network topology. In a Bluetooth system, a slave node can only communicate directly with its master node. If slave node 22 wishes to communicate with slave node 26, slave node 22 would have to transmit the information it wished to communicate to master node 21. Master node would then transmit the information to slave node 26. In addition to being classified as a master node and slave node, a node may be classified as an idle node. An idle node is a node which is not currently participating in a piconet.

The communication within a piconet is organized by the master which polls each slave according to some polling scheme. Master-to-slave transmissions always start in an even-numbered time slot, while slave-to-master transmissions always start in an odd-numbered time slot. A “frame” includes a pair of corresponding master-to-slave and slave-to-master slots. A master has frames which are in common with those of its slaves since a master's clock and hopping sequence are used to sequence its slaves. A slave is only allowed to transmit in the current slave-to-master slot if it has been polled by the master in the previous master-to-slave slot. The master may or may not include data in the packet used to poll a slave. Bluetooth packets can be one, three or five frames long and they can carry synchronous data (e.g., real-time traffic such as voice data) on Synchronous Connection Oriented (SCO) links. Bluetooth packets can also be used to communicate asynchronous data (e.g., elastic data traffic which tend to be less sensitive to delays) on Asynchronous Connectionless (ACL) links.

Even though data is transmitted in packets, the packets can carry both synchronous data on SCO links which is mainly intended for voice traffic, and asynchronous data on ACL links. Depending on the type of packet that is used, an acknowledgment and retransmission scheme is used (not for SCO packets transferring synchronous data) to ensure reliable data transfer, as well as forward error correction (FEC) in the form of channel coding.

FIG. 3 illustrates an exemplary scatternet. The scatternet is formed by multiple independent and unsynchronized piconets. The piconet 1 of the figure includes master node 33 and slave nodes 31, 32 and 34. Piconet 2 includes master node 35 and slave nodes 34, 36, 37 and 38. Piconet 3 includes master node 39 and the slave nodes 38, 40 and 41. Nodes 34 and 38 are used to implement the scatternet of FIG. 3. If, for example, node 31 wishes to communicate with node 40, then nodes 34 and 38 can be used to forward the packets between the two piconets, and in particular between nodes 31 and 40. Node 31 transfers the information to node 33, the master node of piconet 1. Master node 33 transmits the information to forwarding node 34. Forwarding node 34 then forwards the information to master node 35, which in turn, transmits the information to forwarding node 38. Forwarding node 38 forwards the information to master node 39 which transmits the information to the destination node 40.

A Bluetooth unit can participate in (e.g., belong to, or be a member of) more than one piconet at any time, but it can be a master in only one piconet. Bluetooth units, or nodes, can transmit or receive in only one piconet at a single point in time, but may switch between piconets on a time division basis. That is, a unit switches back and forth between piconets to communicate in one or the other, hence abiding by the premise that a Bluetooth unit can transmit or receive in only one piconet at a single point in time. A set of independent, non-synchronized piconets that are interconnected is referred to as a “scatternet” network. Since different piconets are not synchronized in time, a node tends to lose some time when switching from one piconet to another. Furthermore, the temporal unavailability of nodes must be taken into account when coordinating the communication with them. The inefficiencies of switching between piconets present a significant constraint in building scatternets.

A primary problem in inter-piconet communication is to effectively coordinate the presence of nodes belonging to more than one different piconet such that the occurrence of timing conflicts is minimized. When such a node is assumed to be active by a piconet in which it participates, but the node is in fact not active in the piconet at that time, a conflict occurs. It can also be a problem if a node is active in one of the piconets that assumes the node to be inactive at that time.

### SUMMARY

The present inventors recognized some drawbacks in conventional Bluetooth systems. For example, two effects that can significantly reduce the efficiency of the polling based communication in Bluetooth scatternets are as follows. First, reductions in efficiency can occur when nodes having no data to transmit may be unnecessarily polled, while other nodes with data to transmit may have to wait to be polled. Second, efficiency may be reduced when, at the time of an expected poll, one of the nodes of a communicating node pair may not be present in the piconet (e.g., the node that is being polled is not listening or the node that is expecting to be polled is not polled).

The present invention overcomes these and other drawbacks of conventional approaches. The present invention provides advantages in communications between devices by introducing communication rules that Bluetooth nodes can follow to coordinate their presence in different piconets and adjust the intensity of polls according to the amount of data to be transmitted. The coordination in the communication is achieved without the requirement for sending signaling messages.

In accordance with one embodiment of the present invention, a method of communicating between nodes in an ad hoc polling based communication infrastructure may be achieved by defining frames which include checkpoints for the nodes. A node may then check one or more of the checkpoints for presence of the another node which is linked to the first node. The node checking intensity, that is, the rate at which a node checks its peers, may be adjusted in response to presence or absence of the other node at the checkpoints. Communications between the nodes may be carried out by transmitting a signal from one node to the other in accordance with the adjusted node checking intensity.

In accordance with embodiments of the present invention, frames are time slot pairs for communication between the first and second nodes. The frames may each contain one or more of the following checkpoint information: an offset, a time interval, usage data and utilization data.

In accordance with some embodiments of the present invention, the positions of the checkpoints are substantially periodic. In other embodiments, the positions of the checkpoints are pseudo randomly generated.

In accordance with embodiments of the present invention, the step of adjusting the node checking intensity may involve increasing the node checking intensity by changing one or more dead checkpoints into alive checkpoints. Similarly, the node checking intensity may be decreased by changing one or more alive checkpoints into dead checkpoints.

In accordance with embodiments of the present invention, the checkpoint usage value may be increased or decreased in response to utilization, usage, or the presence or absence of the nodes at one or more checkpoint.

Explanation of some of the variables and parameters used in the present disclosure is provided below. These terms and parameters may apply to either the periodic or the pseudo random cases, or to both cases. Their meaning is consistent with the explanation set forth below, although those of ordinary skill in the art would know that these definitions may include equivalent concepts and meanings, depending upon the context or situation in which the variable or parameter is used.

The checking intensity is the rate at which the checkpoints corresponding to a particular node pair follow each other, that is, the rate at which the checkpoints corresponding to a given node pair appear in time.

The variable T_{(check)}⁽ⁱ⁾ represents the current length of the checking period in number of frames. The checking period is defined as being inversely related to the checking intensity [i.e., checking period=1/(checking intensity)].

The variable t_{(check)}⁽ⁱ⁾ stores the time of the next checkpoint. This time may be specified by the Bluetooth clock of the master node.

The variable ρ represents a node's checkpoint utilization. A checkpoint is considered to be “utilized” if there has been user data transmission at the checkpoint either in the master to slave or slave to master directions or in both directions.

The variables ρₘₐₓ and ρₘᵢₙ represent the utilization thresholds that trigger the increase and decrease procedures, respectively. In accordance with some embodiments of the present invention, the relationship ρₘₐₓ>2×ρₘᵢₙ is maintained to avoid oscillations. The ρₘₐₓ and ρₘᵢₙ parameters apply to both periodic and pseudo random embodiments.

The variables N_{sample,incr} and N_{sample,decr} represent the number of checkpoint samples to be measured in order for the measured values to be considered confident. The value of these parameters may vary for the increase and decrease procedures, respectively. Moreover, these values may depend on the checking frequency, the available resources of the node, the amount of user data to be transmitted. These parameters apply both for the periodic and pseudo random cases.

The variables q_{uti,incr} and q_{uti,decr} represent the parameters of the corresponding moving average methods, which apply both for periodic and pseudo random checkpoints.

The variable ρₘₐₓ^{(node)} represents the node utilization threshold, which is used in the increase procedure and it applies both for the periodic and pseudo random cases.

The variable μₘᵢₙ represents the usage threshold that triggers the decrease procedure. In preferred embodiments, this parameter applies only for the pseudo random case.

The variables q_{usage} and N_{sample,usage} represent the moving average parameter and the minimum sample size parameter of the usage measurement. In preferred embodiments, they apply only for the pseudo random case.

The variable q_{uti,node} represents the moving average measurement related to the node's utilization measurement.

The variable Aᵢₙᵢₜ represents the age value that the new checkpoints are initialized to after a checking intensity increase. This value may also depend on the checking frequency, the available resources of the node, the amount of user data to be transmitted, or like parameters. In preferred embodiments, this parameter applies only for the periodic case.

The variable s represents the length of the sequence numbers in bits. In preferred embodiments, this parameter applies only to the periodic case.

The variables Tₘₐₓ and Tₘᵢₙ represent the maximum and minimum checking periods, respectively. In preferred embodiments, the length of a checking period is a number of frames equal to a power two. These parameters apply both for the periodic and pseudo random cases.

### BRIEF DESCRIPTION OF THE DRAWINGS

The objects, features and advantages of the present invention will become more readily apparent to those skilled in the art upon reading the following detailed description, in conjunction with the appended drawings, in which:

FIG. 1 depicts an exemplary Bluetooth piconet;

FIG. 2 illustrates a piconet with a master node 21 and a plurality of slave nodes 22-28 arranged in a star network topology;

FIG. 3 illustrates an exemplary scatternet;

FIGS. 4(a) and 4(b) respectively depict exemplary checkpoint arrangements of node pair A and B in a strictly periodic and a pseudo random checkpoint positioning scheme, in accordance with the present invention;

FIG. 5 is a flowchart of an exemplary method of measuring usage, in accordance with the present invention;

FIG. 6 is a flowchart of an exemplary method of updating age counters, in accordance with the present invention;

FIG. 7 depicts a flowchart of an exemplary method of measuring utilization for nodes having either periodic checkpoints or pseudo random checkpoints, in accordance with the present invention;

FIGS. 8(a) and 8(b) respectively depict exemplary periodic and pseudo random checkpoint embodiments for a scatternet, as shown in FIG. 8(a), in accordance with the present invention;

FIG. 9 is a flowchart of an exemplary initialization process for nodes having periodic checkpoints, in accordance with the present invention;

FIG. 10 is a flowchart of an exemplary method of decreasing checking intensity for node pairs having pseudo random checkpoints, in accordance with the present invention;

FIG. 11 is a flowchart of an exemplary method of decreasing the checking intensity for node pairs having periodic checkpoints, in accordance with the present invention;

FIG. 12 is a flowchart depicting an exemplary follow decrease procedure for periodic checkpoint embodiments, in accordance with the present invention;

FIGS. 13(a) and 13(b) provide an exemplary checkpoint illustration for the process of decreasing checking intensity for a node pair having periodic and pseudo random checkpoints, respectively;

FIG. 14 is a flowchart of an exemplary method of increasing checking intensity, in accordance with the present invention;

FIG. 15 depicts exemplary checkpoints for two nodes in a periodic embodiment, wherein one node increases the checking intensity;

FIG. 16 is a flowchart of an exemplary method of packet transmission reception for node pairs having periodic or pseudo random checkpoints, in accordance with the present invention;

FIGS. 17-20 depict exemplary embodiments associated with pseudo random checkpoint generation, in accordance with the present invention; and

FIGS. 21(a) and 21(b) depict one exemplary hardware configuration for implementing the present invention.

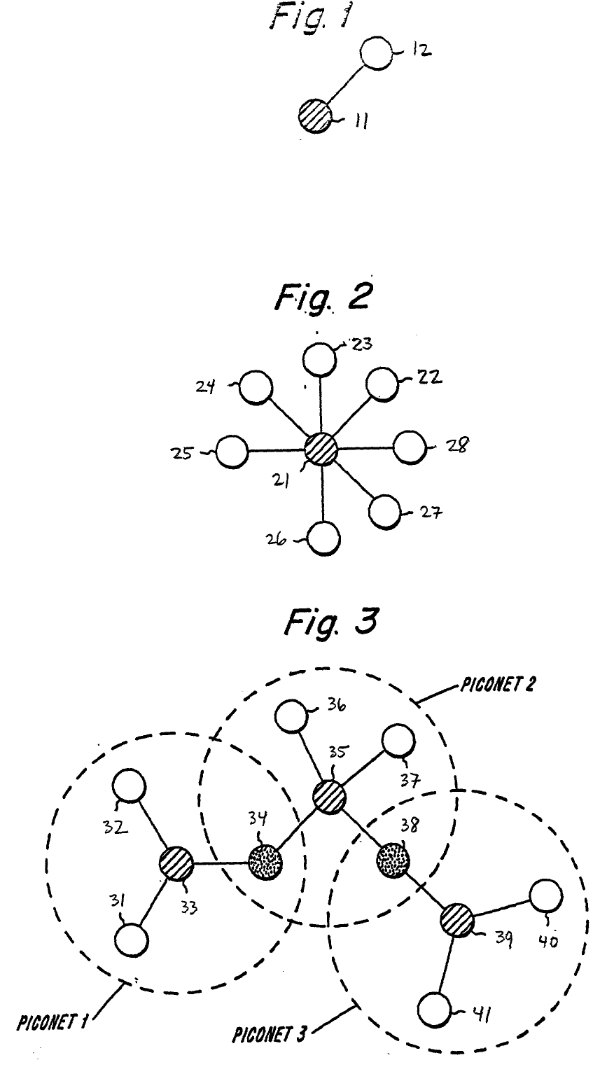

### DETAILED DESCRIPTION

A number of exemplary embodiments of the invention will now be described in greater detail, with some aspects of the invention described in terms of sequences of actions to be performed by elements of a processor or computer system. It will be recognized that various actions disclosed herein may be performed by hard-wired electrical circuits, or by processor program instructions performed on one or more processors, or by some combination of each. Other embodiments of the invention may be comprised entirely of instructions stored in a computer readable storage medium, for execution by one or more processors to implement the methods and systems of the invention. All of these various forms and embodiments are contemplated to be within the scope of the invention.

Although, for ease of explanation, the present invention is described herein in terms of the Bluetooth environment, the present invention can be practiced in any polling based communication infrastructure. In preferred embodiments of the present invention used in a polling based communication infrastructure, a node may be polled by some nodes and may poll other nodes, but preferably a particular node can listen or transmit to only one other node at the same time.

In accordance with embodiments of the present invention, the coordination between Bluetooth nodes is achieved through the use of implicit rules in the communication. The principle of this approach is that nodes rely on implicit rules and on previous communications in the past to predict the position of time frames when they can communicate by transmitting signals to each other. Although the success of a particular poll may not necessarily be guaranteed, nodes can easily predict the position of time frames where the presence of the peer is expected with high probability by the implicit rules in the communication. The solution does not require the addition of new signaling messages or any modifications to the packet types and basic procedures defined in the Bluetooth Baseband specification and it is applicable both for intra- and inter-piconet communication. However, in accordance with an alternative embodiment, the implicit rules of the present invention can be replaced by explicit signaling messages as an optional extension, provided that such messages are available. If such use of explicit signaling is specified, the increased communication overhead and the additional protocol complexity should be taken into account.

In accordance with exemplary embodiments of the present invention, there are predictable points in time in relation to each master-slave node pair when a packet exchange can be initiated. These predictable pairs of slots where the polling and the response take place are called “checkpoints.” The checkpoints are predictable points in time in relation to a pair of nodes when the two nodes regularly meet.

The activity of being present at a checkpoint is referred to herein as a “check.” A master node may actively check its slave by sending a packet to the slave. A slave node may passively check the master by listening to it. If a node wants to initiate a data transmission with one of its peers, it waits until the next checkpoint when the peer is expected to show up and they can start exchanging user data packets, in accordance with conventional Bluetooth protocols, using the successive frames after the checkpoint.

In accordance with embodiments of the present invention, during a communication, the checkpoint intensity may be increased or decreased depending on the amount of user data to be transmitted and on the available capacity of the nodes. The expected behavior of nodes is that they show up at each checkpoint on all of their links, although they are allowed to occasionally skip some checkpoints. If a node consistently misses some of the checkpoints, for instance because it is getting to be overloaded and can not attend all of its checkpoints, the intensity of checkpoints will be decreased at both nodes following the implicit rules. That is, a node pair maintains approximately only as many checkpoints as are actually visited and utilized. Potentially every frame can be a checkpoint. The checkpoints that are actually used from the set of all potential checkpoints are defined as “alive” checkpoints, while the rest are called “dead” checkpoints.

To designate the position of alive checkpoints, embodiments of the present invention provide two solutions in the form of a strictly periodic scheme and a pseudo random scheme. In the “periodic” positioning of checkpoints, successive checkpoints on a link follow each other with a fixed time period, denoted with T_{(check)}⁽ⁱ⁾ for the ith link of the node. That is, there is one checkpoint within each time interval of length T_{(check)}⁽ⁱ⁾ and the position of the checkpoint within this interval is always the same. For a “pseudo random” scheme there is a base time window of length T_{(check)}⁽ⁱ⁾ and the position of the checkpoint within this window may change from one time window to another in a pseudo random manner.

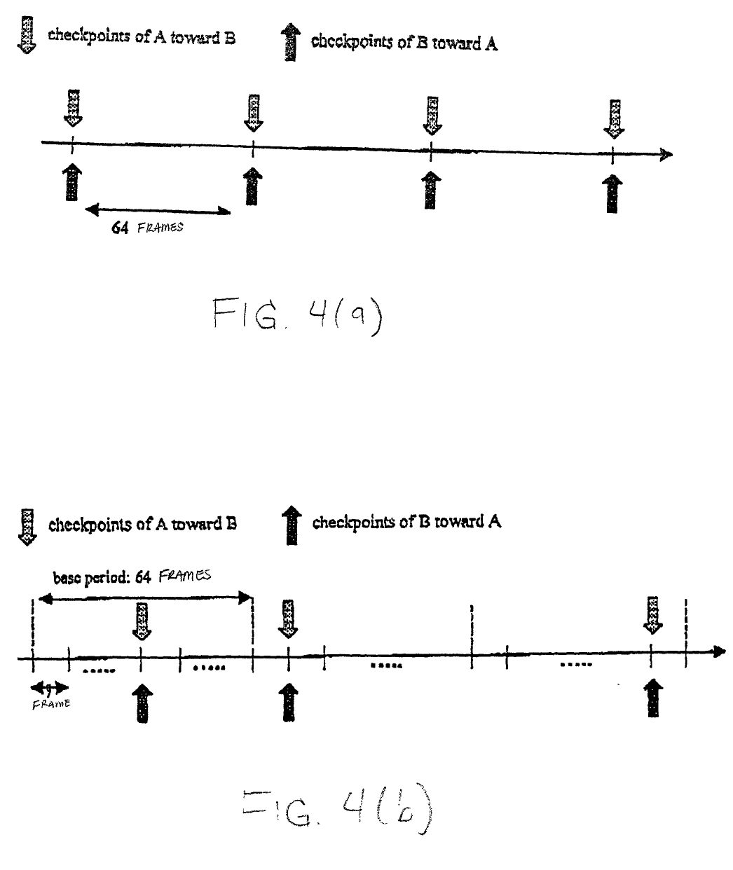

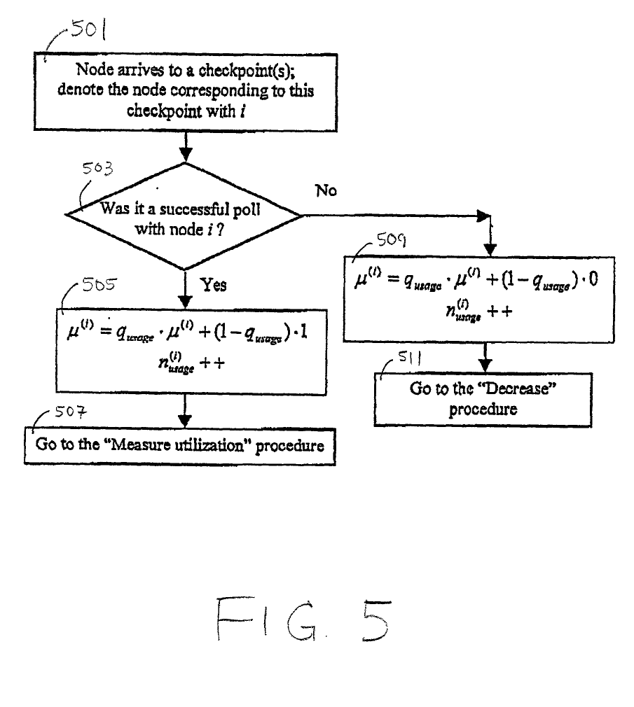

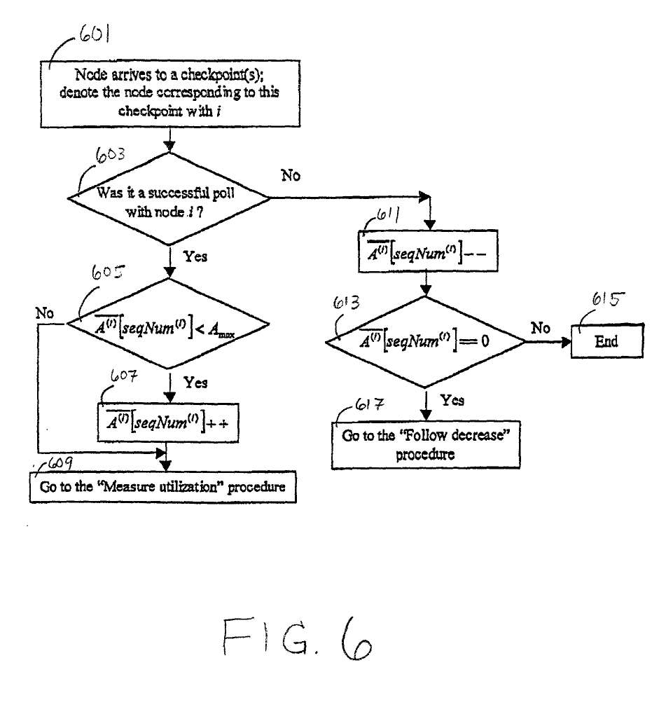

FIGS. 4(a) and 4(b) depict examples of checkpoint arrangements of node pair A and B in a strictly periodic and a pseudo random checkpoint positioning scheme, respectively, in accordance with the present invention. Note that if a node has more than one Bluetooth connection it maintains checkpoints on each of them. A typical length of checking period could be around 128 frames, but may have values from a wide range, e.g., from four frames to 1600 frames or more. In embodiments involving periodic checkpoints, the offset, which is the point in time where the sequence of periodic checkpoints starts, together with the length of the period, unambiguously designate the checkpoints.

In embodiments involving the pseudo random positioning of checkpoints, the pseudo random generator is preferably such that the same pseudo random sequence is produced in both nodes and the set of checkpoint positions at a lower checking frequency is a subset of checkpoint positions at any higher checking frequencies. In a preferred embodiment, this latter feature holds for the periodic case as well, since this is what insures that a node pair selecting different checking intensities can still communicate. In the periodic case this condition can readily be satisfied by appropriately selecting the length of possible checking periods, which preferably have a number of frames equal to a power of two. Similarly, in the pseudo random scheme it is preferable that the possible lengths of the base time window, in which a checkpoint is selected pseudo randomly, also be a length in frames equal to a power of two. The Bluetooth clock of the master and the Bluetooth device address of the slave may be used as the input to the pseudo random generator. Each Bluetooth device has one Bluetooth device address associated with it which is often a 48 bit address burnt into the hardware during manufacturing. In the case of MAC addresses, these addresses are allocated according to the IEEE802 standard to ensure their uniqueness. They may also be referred to as an IEEE MAC address or IEEE device address.

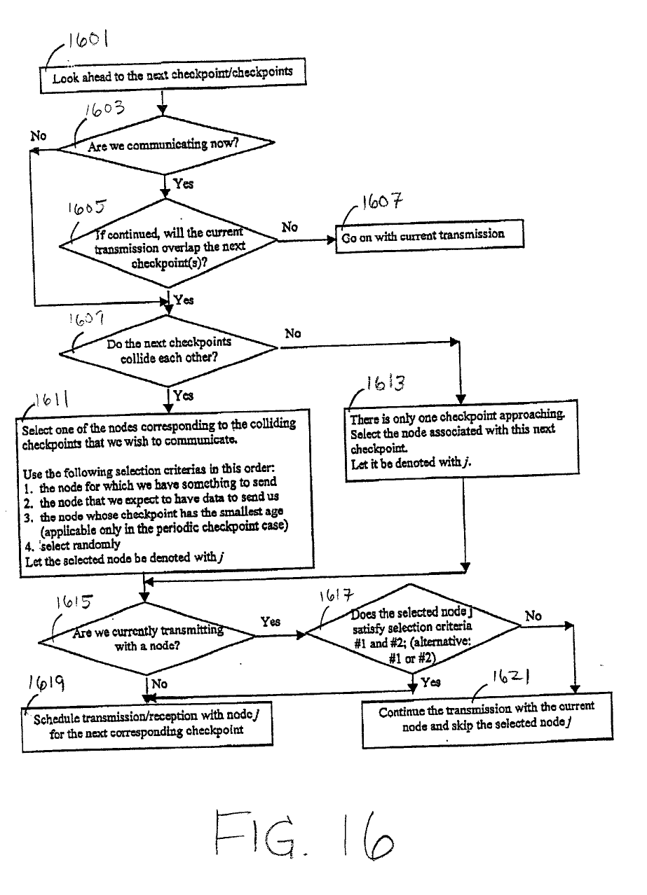

The same pseudo random generator that is used for generating the hop frequencies in the Bluetooth Baseband Specification 1.1 can be modified in accordance with the present invention for use in generating the position of checkpoints as well. For illustrative purposes, an exemplary pseudo random generator is disclosed herein in conjunction with FIGS. 17-20. Other pseudo random generators including various equivalent means of producing a pseudo random sequence may be used in accordance with the present invention.

In inter-piconet communication, the bridging node switches between the piconets in active mode, in accordance with the present invention. A node can leave the piconet anytime without prior notice. Inter-piconet communication can be achieved such that the bridging node maintains alive checkpoints in each of the piconets it participates and regularly shows up at these checkpoints. The communicating party of the bridging node will learn the checkpoints when the bridging node is not present. The checkpoints that the bridging node misses will become dead. The present invention is advantageous in that being present at a checkpoint is not a strict rule and a node communicating in one piconet may miss one or more checkpoints in the rest of its piconets without those checkpoints becoming dead.

One aspect of the present invention involves the management of checkpoints, which includes the designation of the position of the next checkpoint and performing certain measurements (e.g., checkpoint usage, checkpoint utilization, node utilization). Another aspect involves the initialization process, which ensures that two nodes can start communication after a new link has been established or the connection has been reset. Another aspect involves the rules that define when and how a node decreases the checking intensity and how this is discovered by the other party. Another aspect involves the rules that define when and how the checking intensity is increased by the two nodes.

The following disclosure first discusses the management of checkpoints and the kinds of information maintained about the checkpoints. The disclosure also addresses the issue of how the checking process is initialized after a new Bluetooth link is established. Finally, the disclosure discusses the checking intensity decrease and increase procedures.

Checkpoints may be managed in the following manner, in accordance with exemplary embodiments of the present invention. A node stores the current length of the checkpoint interval and the time of the next checkpoint for each of its Bluetooth links separately. For its i^{th} Bluetooth link, the node maintains a memory for the variable T_{(check)}⁽ⁱ⁾ to store the current length of the checking period in number of frames, and another memory for the variable t_{(check)}⁽ⁱ⁾ which stores the time (e.g., the Bluetooth clock of the master node) of the next checkpoint. After passing a checkpoint, the value of t_{(check)}⁽ⁱ⁾ is updated to the next checkpoint. In the case of periodic checkpoints the next checkpoint is defined by adding T_{(check)}⁽ⁱ⁾ to the current value of t_{(check)}⁽ⁱ⁾. In the case of pseudo random checkpoints the next checkpoint is obtained by running the pseudo random generator with T_{(check)}⁽ⁱ⁾ and t_{(check)}⁽ⁱ⁾ as inputs.

Maximum and minimum checking intervals may be characterized by Tₘₐₓ and Tₘᵢₙ, respectively. The checking period is preferably a power-of-two number of frames having a value from the interval Tₘᵢₙ≦T_{(check)}⁽ⁱ⁾≦Tₘₐₓ.

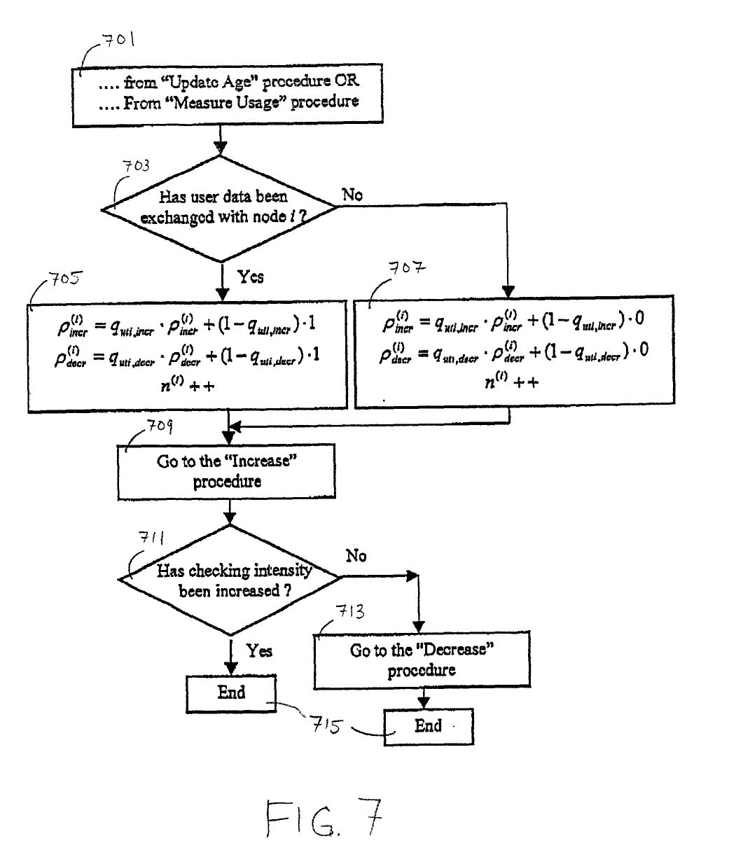

FIG. 5 is a flowchart of an exemplary method of measuring usage, in accordance with the present invention. Checkpoint “usage” is a measure of the appearance of a communicating node pair at the checkpoints, and may be defined as follows. A checkpoint has been used if both nodes have attended the given checkpoint. That is, there has been a successful poll, regardless of whether user data has been exchanged or not. The usage is measured for all currently existing checkpoints. In the case of pseudo random checkpoints, methods similar to that used in measuring the utilization may be employed in the measurement of checkpoint usage. However, different methods of usage measurement may be employed for checkpoints in a strictly periodic scheme as compared to a pseudo random checkpoint scheme.

Checkpoint usage may be measured in accordance with the following method, an exemplary embodiment of the present invention. In step 501, upon arriving at a checkpoint, a node is denoted with the variable i. The method proceeds to step 503 where it is determined whether a successful poll has occurred. In general, the usage of a checkpoint is represented as being equal to a value of 1 if both nodes have attended the checkpoint and there has been a successful poll. Otherwise the usage is equal to 0. A node measures the usage of checkpoints μ⁽ⁱ⁾ on its i^{th} Bluetooth link by updating the μ⁽ⁱ⁾ variable at each checkpoint according to the following, depending upon whether there has been a successful poll or not.

If, in step 503 it is determined that there has been a successful poll at the checkpoint, the method proceeds in accordance with the “yes” branch from step 503 to step 505 to make a determination of usage, μ⁽ⁱ⁾, in accordance with the following relationship:

μ⁽ⁱ⁾=q_{usage}×μ⁽ⁱ⁾+(1−q_{usage})×1

In the above relationship for step 505, and also in the relationship pertaining to step 509, the usage variable μ⁽ⁱ⁾ on the left side of the equation is an update of the usage variable μ⁽ⁱ⁾ on the right side of the equation. The value of q_{usage} is a moving average parameter, in accordance with a minimum number of samples N_{sample,usage} having been observed before the measured usage value is considered statistically confident. Other rate measurement methods, e.g., sliding window can be also used to perform this measurement. Upon completing the determination of pseudo random checkpoint usage μ⁽ⁱ⁾ in step 505, the method proceeds to step 507 to perform the “measure utilization” procedure.

In step 503, if it is determined that there has not been a successful poll at the checkpoint, the method proceeds in accordance with the “no” branch from step 503 to step 509 to determine the usage, μ⁽ⁱ⁾, in accordance with the following relationship:

μ⁽ⁱ⁾=q_{usage}×μ⁽ⁱ⁾+(1−q_{usage})×0

Upon completing the determination of pseudo random checkpoint usage μ⁽ⁱ⁾ in step 509, the method proceeds to step 511 to perform the “decrease” procedure.

For embodiments using periodic checkpoints, a node differentiates checkpoints within the periodic checkpoint sequence and measures the usage of different checkpoints separately. Differentiating checkpoints and maintaining usage variables separately is preferred in the case of a checking period decrease, in order to be able to identify the offset of the decreased checking period, a process which is discussed further in conjunction with FIG. 11. A node differentiates the checkpoints by assigning sequence numbers to them. The sequence numbers are cyclic and are in the interval (0 . . . (2^{s}−1)) where s is a parameter which can be set by each node independently. The sequence numbers are relevant only within a given node. That is, different peer nodes may independently provide sequence numbers for the same checkpoints. In one embodiment, it is assumed that s=1, which means that sequence numbers 0 and 1 are alternating.

FIG. 6 is a flowchart of an exemplary method of updating age counters, in accordance with the present invention. The usage of a checkpoint may be measured with the age counter. For each checkpoint with different sequence number, a separate age counter is maintained. Each time a checkpoint is used the age counter is incremented by one. The procedure for updating age counters is preferably invoked each time the node arrives to a checkpoint.

The procedure begins in step 601 by denoting the node corresponding to the checkpoint with the variable i. The method proceeds to step 603 where it is determined whether there has been a successful poll with the node i. If there has been a successful poll, the method proceeds in accordance with the “yes” branch from step 603 to step 605. Otherwise the method proceeds in accordance with the “no” branch to step 611. The \overline{A⁽ⁱ⁾}seqNum⁽ⁱ⁾ variable depicted in various steps of FIG. 6 denotes the sequence number of the current checkpoint, and the index i designates the peer node that this checkpoint belongs to. The vector \overline{A⁽ⁱ⁾}, stores the age values of checkpoints with different sequence numbers. The length of the vector \overline{A⁽ⁱ⁾} is equal to 2^{s}. The age of a checkpoint preferably takes values from the interval (0, Aₘₐₓ), where the value of Aₘₐₓ is relatively small, for example seven, in which case three bits are enough to store an age counter. New checkpoints may be initialized to a value of Aᵢₙᵢₜ, which is a system parameter.

In one embodiment, the age counters of the checkpoints are updated according to the usage of the checkpoint as follows. If the checkpoint has been used, the age counter is incremented by one, provided that the maximum age value Aₘₐₓ has not yet been reached. This is achieved in step 605 by determining whether the relationship \overline{A⁽ⁱ⁾}[seqNum⁽ⁱ⁾]<Aₘₐₓ holds true. If this relationship is false, that is, upon reaching the maximum age Aₘₐₓ, the method proceeds in accordance with the “no” branch from step 605 to step 609 and the checkpoint counter will not be increased, as long as it does not fall below Aₘₐₓ. On the other hand, if the relationship of step 605 is true and the maximum age Aₘₐₓ has not been reached, the method proceeds in accordance with the “yes” branch to step 607 and \overline{A⁽ⁱ⁾}[seqNum⁽ⁱ⁾] is incremented accordingly. The method then proceeds from step 607 to step 609 for performance of the “measure utilization procedure.”

If there has not been a successful poll, as determined in step 603, that is, the checkpoint has not been used, the method proceeds in accordance with the “no” branch to step 611. In step 611, the age counter is decreased by one, provided that it is above 0. Upon completing step 611, the method proceeds to step 613 where it is determined whether the age counter equals zero. If, in step 613 it is determined that \overline{A⁽ⁱ⁾}[seqNum⁽ⁱ⁾]#0, then the method proceeds in accordance with the “no” branch to step 615 and ends. Hence, if the age counter decreases down to zero for a predetermined amount of time the checkpoint will be considered to be dead and the age counter will be no longer maintained for this checkpoint. On the other hand, if \overline{A⁽ⁱ⁾}[seqNum⁽ⁱ⁾]=0, the method proceeds in accordance with the “yes” branch from step 613 to step 617 for performance of the “follow decrease” procedure. In regard to FIG. 6, it should be noted that there may be more than one checkpoint scheduled for the same frame, in which case the age counters of all checkpoints are updated.

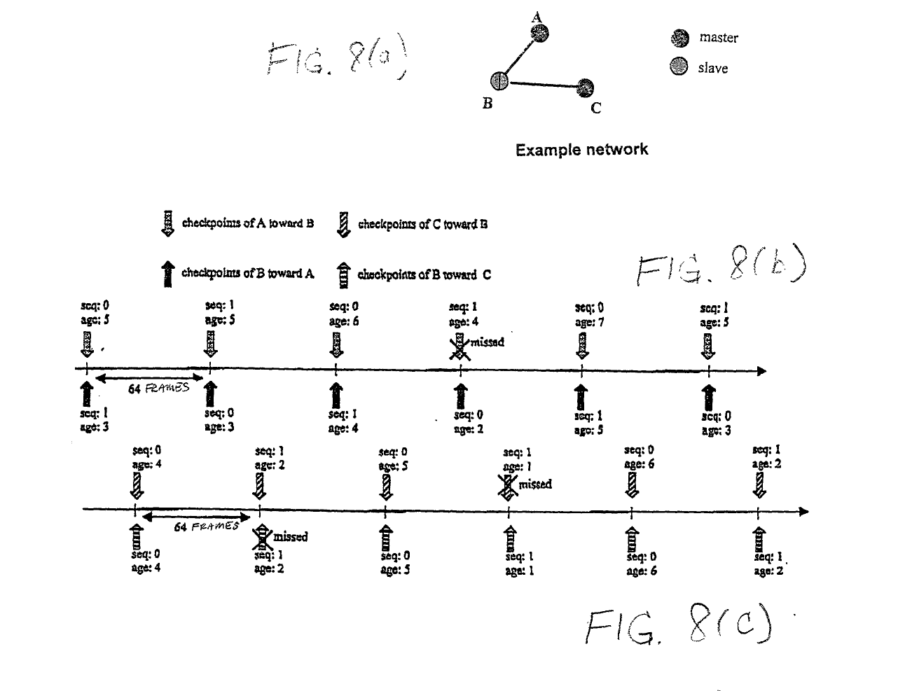

FIG. 7 is a flowchart of an exemplary method of measuring utilization for nodes having either periodic checkpoints or pseudo random checkpoints, in accordance with the present invention. In accordance with embodiments of the present invention, a node measures the utilization and the usage of checkpoints, which provides the inputs to the procedures for checking intensity increase and intensity decrease. A checkpoint is considered to be “utilized” if there has been user data transmission at the checkpoint either in the master to slave or slave to master directions or in both directions. A given checkpoint is considered to be unutilized if there has been no user data transmission at the checkpoint just a POLL-EMPTY packet pair exchange. Checkpoint utilization measurements may be achieved as follows.

The utilization is preferably measured only for the checkpoints where both nodes have attended. This condition is met in step 701 where process follows from the “update age” procedure” or the “measure usage” procedure. If there has been no successful poll at a given checkpoint due to the unavailability of any of the nodes, the checkpoint will not be taken into account in the utilization measurement. The method proceeds to step 703 where it is determined whether user data has been exchanged with node i. If user data has been exchanged, the method proceeds in accordance with the “yes” branch to step 705. If no exchange of user data has taken place, the method proceeds in accordance with the “no” branch to step 707. In general, the utilization of a checkpoint is represented as being equal to 1 if it has been utilized, otherwise it equals 0. The measurement of the utilization of checkpoints may be achieved using rate measurement methods such as moving average or sliding window, or other like rate measurement methods. For ease of illustration, the ensuing exemplary embodiment involves performing the measurements based on the moving average method.

The measured utilization values will serve as the inputs to the increase procedure and the decrease procedure. Therefore, the utilization value measurements may be performed with different parameters for the increase and decrease procedures, respectively. Hence, in both step 705 and in step 707, a node separately measures the utilization of checkpoints ρ_{incr}⁽ⁱ⁾ and ρ_{decr}⁽ⁱ⁾ on its ith Bluetooth link for the increase and decrease procedures. The variables ρ_{incr}⁽ⁱ⁾ and ρ_{decr}⁽ⁱ⁾ store the measured utilization values of checkpoints corresponding to the i^{th} link of the node for the increases procedure and the decreases procedure, respectively. The variable n⁽ⁱ⁾ in steps 705 and 707 counts the number of checkpoints that have been measured. Upon successfully polling at a checkpoint, the ρ_{incr}⁽ⁱ⁾ and ρ_{decr}⁽ⁱ⁾ variables are updated according to the following relationships, depending whether or not user data has been exchanged.

If, in step 703, it is determined that user data has been exchanged, the method proceeds in accordance with the “yes” branch to step 705 for a determination of the utilization values ρ_{incr}⁽ⁱ⁾ and ρ_{decr}⁽ⁱ⁾ in accordance with the following relationships:

ρ_{incr}⁽ⁱ⁾=q_{uti,incr}×ρ_{incr}⁽ⁱ⁾+(1−q_{uti,incr})×1

ρ_{decr}⁽ⁱ⁾=q_{uti,decr}×ρ_{decr}⁽ⁱ⁾+(1−q_{uti,decr})×1

In the above relationship for step 705, and also in the relationship pertaining to step 707, the utilization values ρ_{incr}⁽ⁱ⁾ and ρ_{decr}⁽ⁱ⁾ on the left sides of the equations are updates of the utilization values ρ_{incr}⁽ⁱ⁾ and ρ_{decr}⁽ⁱ⁾ on the right sides of the equations. If step 703 determines that no user data has been exchanged there is only a POLL-EMPTY packet pair, and the method proceeds in accordance with the “no” branch to step 707 for a determination of the utilization values ρ_{incr}⁽ⁱ⁾ and ρ_{decr}⁽ⁱ⁾ in accordance with the following relationships:

ρ_{incr}⁽ⁱ⁾=q_{uti,incr}×ρ_{incr}⁽ⁱ⁾+(1−q_{uti,incr})×0

ρ_{decr}⁽ⁱ⁾=q_{uti,decr}×ρ_{decr}⁽ⁱ⁾+(1−q_{uti,decr})×0

The parameters q_{uti,incr}, q_{uti,decr} determine the time scale on which the measured utilization values are averaged. The q_{uti,incr} and q_{uti,decr} parameters can be different for the increase and decrease procedures. As a parameter of the rate measurement, a minimum number of samples must be observed before the measured utilization value can be used in increasing or decreasing the intensity of checkpoints. These minimum number of samples are N_{sample,incr} and N_{sample,decr} for the increase and decrease procedures, respectively.

Upon completing either step 705 or step 707, the method proceeds to step 709 which represents a loop to the “increase” procedure, and then proceeds to step 711. In step 711, if it is determined that the checking intensity has not increased, the method proceeds in accordance with the “no” branch to step 713 which represents a loop to the “decrease” procedure. Upon completing step 713, the method proceeds to step 715 and the “update age” procedure ends. Alternatively, the procedure also ends in accordance with the “yes” branch from step 711 if it is determined that the checking intensity has increased.

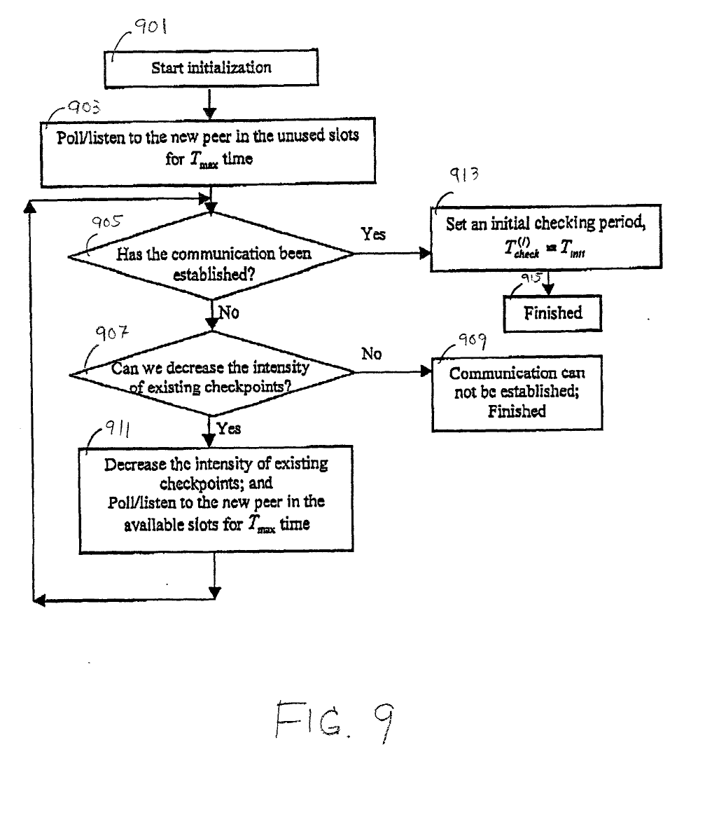

FIGS. 8(a) and 8(b) respectively depict exemplary periodic and pseudo random checkpoint embodiments for a scatternet, as shown in FIG. 8(a). In the checking process the master and slave nodes play the same role. Thus, from the aspect of checkpoints, master and slave roles are not necessarily differentiated. A node only needs to be aware of the number of Bluetooth links it has and the checkpoints on them, in order to manage its own checkpoints. However, it may be necessary to know the master-slave roles when managing the scheduling of checkpoints of a node according to the present invention, when the node belongs to different conventional piconets which have their own frame synchronization.

In the periodic checkpoint example depicted in FIG. 8(b), the situation is stabilized. That is, the nodes have a settled checking period on each of their Bluetooth links, and, for example, both node pairs may check their peers at every 64^{th} frame. The sequence numbers and the aging of frames are also illustrated in the figure. As disclosed above, a preferred embodiment requires maintaining sequence numbers and age counters only in the case of periodic checkpoints. Furthermore, being present at a checkpoint is not a strict requirement in a preferred embodiment. The node is allowed to miss an alive checkpoint occasionally if it cannot show up for some reason. For example, one possible reason for missing an alive checkpoint could occur if the node has started a packet transmission with another node which overlaps the current checkpoint.

FIG. 8(c) depicts a case of pseudo random checkpoints. Some differences from the example shown in the figure could be that the position of checkpoints within the time window of the checking period changes pseudo randomly from one time window to another, and instead of age counters and sequence numbers the μ⁽ⁱ⁾ usage measurements are maintained.

In accordance with the present invention, the measurement of node utilization, ρ^{(node)}, is conceptually similar to checkpoint utilization, ρ, discussed above. For node utilization measurements, a node preferably measures its “absolute utilization,” which is defined as the fraction of time frames where the node has communicated, including transmission and reception, over the total number of time frames. To measure the absolute utilization of the node, the moving average method may be used. In alternative embodiments, other like measurement techniques may be used.

In a preferred embodiment, each node measures its own utilization ρ^{(node)} and updates the ρ^{(node)} variable after each N_{uti,window} number of frames in accordance with the following relationship:

ρ^{(node)}=q_{node,uti}×ρ^{(node)}+(1−q_{node,uti})×ρ^{(window)}

where ρ^{(window)} is the fraction of time frames in the past time window of length N_{uti,windows} where there has been a successful packet exchange (e.g., both the master and slave were present) over the total number of time frames N_{uti,windows}. In the above relationship, the node utilization variable ρ^{(node)} on the left side of the equation is an update of the node utilization variable ρ^{(node)} on the right side of the equation.

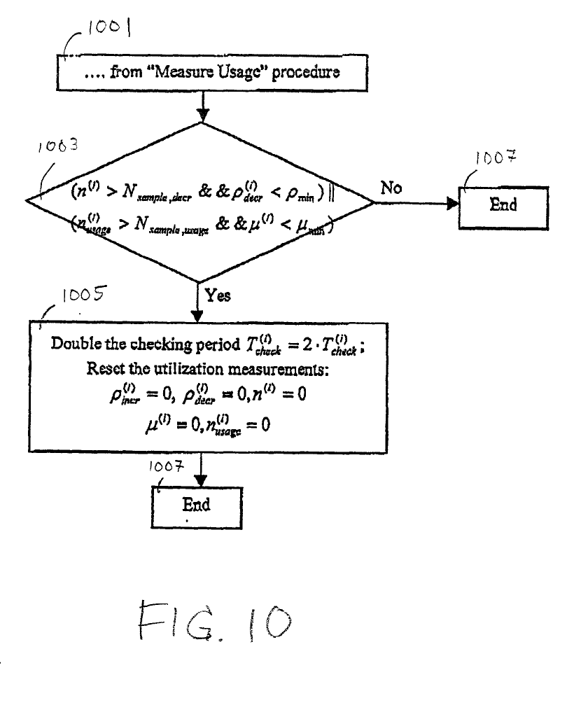

FIG. 9 is a flowchart of an exemplary initialization process for nodes having periodic checkpoints, in accordance with the present invention. For periodic checkpoint embodiments, the initialization process often requires more efforts than that of pseudo random schemes. The initialization method begins in step 901 in which the two nodes find a common offset where the sequence of periodic checkpoints starts. The selection of checking periods does not necessarily have to be coordinated, since the increase and decrease procedures can adjust to a common checking period, as in the pseudo random case. Following the beginning initialization step 901, nodes may find a common offset after establishment of a new Bluetooth link or after a reset in the connection by progressing to step 903 and taking the following steps.

In the embodiment depicted in FIG. 9, the nodes first try to find their new peers in step 903 by checking the possible checkpoints that are not used by an already existing communication. This is achieved by having the master poll its slaves in the unused master-slave frames, and similarly, having slaves listen for their master in each master-slave frame that does not collide with any of the slave's existing checkpoints. If the communication can not be established at the unused frames until a certain timeout expires, the nodes will start to miss some of the checkpoints of existing communications, thus making more capacity available for the checking of the new node.

In step 905 it is determined whether the communication has been established. If the communication has been established, the method proceeds in accordance with the “yes” branch from step 905 to step 913. In step 913, an initial checking period is set such that, T_{(check)}⁽ⁱ⁾=Tᵢₙᵢₜ. Upon setting the initial checking period in step 913, the method proceeds to step 915 where the initialization procedure ends.

During the initialization process there may be a need to decrease the checking intensity of already existing connections in order to make time frames available for the new connection. In accordance with the present invention, any of several strategies can be used to decide which checkpoints should be decreased first. In accordance with step 905, if communication with the new node could not be established within a time interval of length Tₘₐₓ, the method proceeds to step 907 in accordance with the “no” branch from step 905 for a determination of whether the intensities of existing checkpoints may be decreased. If, in step 907 it is determined that the intensities may not be decreased, the method proceeds to step 909 via the “no” path from step 907. In step 909, further steps may be taken in accordance with a finding that the communication cannot be established.

If the intensities can be decreased, the method proceeds to step 911 in accordance with the “yes” path from step 907. In step 911 the checking intensities of all existing connections are decreased by a factor of one-half, or by another predetermined amount. Once the intensity is decreased in step 911, the method loops back to step 905 for another determination of whether the communication can be established.

In this way, the reduction of checking intensities may be repeated until the communication with the new peer is established or the checking intensity of existing connections decrease to the minimum (e.g., Tₘₐₓ). The first pair of frames where the two nodes can communicate will designate the offset of the checking period, where the periodic checks start. The initialization procedure ends either upon establishing communication in accordance with the “yes” path from step 905, or upon determining that the checking intensity cannot be further reduced in accordance with the “no” path from step 907.

In regard to pseudo random checkpoint embodiments, separate initialization procedures are typically not required. The pseudo random generator can be defined such that once a master-slave node pair share the same master's clock and slave's MAC address information, the checkpoints at a lower checking frequency will be a subset of the checkpoints of higher checking frequency, regardless of when the nodes start generating checkpoints and regardless of the length of the selected base checking period. That is, two nodes starting checkpoint generation at different time instants with different checking intensities will be able to communicate. The selection of an appropriate checking intensity is a decision of the node. The checking intensity selection may depend upon the free capacities of the node, the amount of data to transmit, or other such parameter. Once the communication is established, the increase and decrease procedures of the present invention will adjust the possibly different initial checking intensities to a common value.

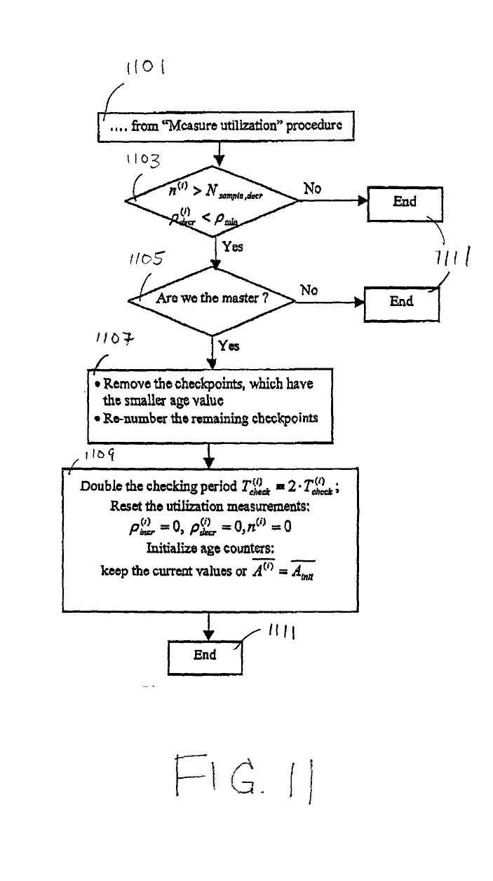

FIGS. 10 and 11 are flowcharts of exemplary methods, in accordance with the present invention, of decreasing checking intensity for node pairs having pseudo random checkpoints or having periodic checkpoints, respectively. The checking intensity, which may also be called checking frequency, is frequency at which a node checks its checkpoints. The checking intensity is defined as being inversely related to the checking period which represents the length, in frames, between those checkpoints which a node is currently set to check.

In the checking intensity decrease process the node that initiates the decrease systematically misses some of the alive checkpoints. The other node that discovers this decrease will follows the decrease. Accordingly, there are defined rules that trigger the checking intensity decrease in one of the nodes, and rules that allow the other node to follow this decrease. There may be some differences in these procedures depending on whether periodic or pseudo random checkpoints are involved.

FIG. 10 is a flowchart of an exemplary method of decreasing the checking intensity for node pairs having pseudo random checkpoints, in accordance with the present invention. The method of decreasing checking intensity begins in step 1001, which may be entered, for example, from the measure usage procedure. From step 1001 the method proceeds to step 1003 where it is determined whether a node is seeking to decrease the checking intensity. The variable n⁽ⁱ⁾ represents a tally of the number of checkpoints that have been measured. The variables N_{sample,incr} and N_{sample,decr} represent a number of checkpoint samples which must be measured for the measured values to be considered confident. Upon satisfying the criteria of step 1003 for decreasing the checking intensity, the method proceeds in accordance with the “yes” branch from step 1003 to step 1005. If, in step 1003, the criteria for decreasing the checking intensity is not satisfied, the method proceeds in accordance with the “no” branch from step 1003 to step 1007 where the decreasing checking intensity method ends.

In step 1005, if one of the nodes decides to decrease checking intensity, it increases the current check period by a factor of two, or four, or another predetermined amount. In accordance with one embodiment, the checking period can be only be doubled once per step. After one of the nodes has increased the checking period, that node will show up only at every 2^{nd}, or 4^{th}, etc., of the current checkpoints. For pseudo random checkpoint embodiments, the decrease may be performed by increasing, e.g., doubling, the T_{(check)}⁽ⁱ⁾ parameter. Since this parameter is one of the inputs of the pseudo random generator, the checkpoints will be generated according to the new period and due to the characteristics of the pseudo random generator the remaining checkpoints will be a subset of the original checkpoints.

As a consequence of decreasing the checking intensity, the usage of checkpoints at the peer node will decrease, which allows the peer to notice the decrease and follow. That is, since the node which made the adjustment no longer shows up at checkpoints which are not current, the other node will notice the absence and its usage for that checkpoint will decrease. In this way, once the non-adjusting node detects that the other node no longer shows up for certain checkpoints, the non-adjusting node can follow suit.

The checking intensity decrease may be initiated by any event that triggers a checking intensity decrease. In accordance with alternative embodiments, the event used to initiate checking intensity decrease may vary depending on the actual implementation. What needs to be the same in all nodes is the way the decrease is performed in order to allow the peer node to realize the decrease and follow. In one embodiment, a checking intensity decrease, or an increase, are triggered by the utilization of existing checkpoints. If the utilization of the checkpoints falls below a minimum threshold, ρₘᵢₙ, such that ρ_{decr}⁽ⁱ⁾<ρₘᵢₙ, the current checking period will be doubled or increased by another predetermined amount. Once the checking intensity has been decreased, the method proceeds from step 1005 to step 1007 where it ends.

FIG. 11 is a flowchart of an exemplary method of decreasing the checking intensity for node pairs having periodic checkpoints, in accordance with the present invention. The method of decreasing checking intensity, which may be entered from the measure usage procedure of FIG. 5, begins in step 1101. The method proceeds from step 1101 to step 1103 where it is determined whether a node is seeking to decrease the checking intensity. The variable n⁽ⁱ⁾ represents a sum of the number of checkpoints that have been measured, and the variables N_{sample,incr} and N_{sample,decr} represent a number of checkpoint samples to be measured in order to establish statistical confidence. For example, in one embodiment, the value of ρₘᵢₙ may be within the interval 0.3 to 0.4. The node collects N_{sample,decr} number of samples before the measured utilization is considered to be confident and can be used to decide about the decrease of checking intensity. For N_{sample,decr} set to a small value, the utilization of the checkpoints is preferably at least ρₘᵢₙ even over a relatively small timescale, otherwise it initiates checking decrease immediately. In one embodiment, the parameter N_{sample,decr} may be reset at each decrease or increase, taking into account for example the current checking intensity and the available resources. If the criteria of step 1103 are not satisfied, the method proceeds in accordance with the “no” branch to step 1111 where the method of decreasing checking intensity ends. If, in step 1103 the criteria of for decreasing the checking intensity satisfied, the method proceeds in accordance with the “yes” branch from step 1103 to step 1105.

Step 1105 may be provided in periodic checkpoint embodiments to avoid conflicts which could lead to lost communications. In the case of periodic checkpoints, there could potentially be a conflict if two nodes performed the decrease at the same time with one of the nodes keeping the checkpoints with sequence number 0, while the other node keeps the ones with sequence number 1. In a situation like this, the nodes could lose contact. In one embodiment, to avoid such conflicts only the master node can start the decrease. Hence, if it is determined that a slave node has initiated the checkpoint decrease procedure, the method proceeds in accordance with the “no” path from step 1105 to step 1111 where the method ends. Upon verifying in step 1105 that the master node has initiated the checkpoint decrease procedure, the method proceeds in accordance with the “yes” path from step 1105 to step 1107.

Steps 1107 and 1109 are performed to decrease the checking intensity. In some periodic checkpoint embodiments, the age of the checkpoints is used as a criteria for keeping or discarding them. In step 1107, the master removes the checkpoints having a smaller age value, and keeps the checkpoints with higher age values. In this way those checkpoints which are kept are the checkpoints that have been visited by both nodes more frequently, which suggests that their position is appropriate for both of them. Upon determining which checkpoints are to be removed and which are to be kept and renumbered, the method proceeds from step 1107 to step 1109.

In accordance with step 1109, the checking decrease may be performed such that every 2^{nd} alive checkpoint is missed. When the age value of the missed checkpoints decreases to zero at the peer node, it realizes the decrease and follows. The offset of the decrease tells whether the checkpoints with sequence number 0 or 1 will be missed (of course the remaining checkpoints will be renumbered after the decrease).

It should be mentioned that in accordance with embodiments having a step 1105, the master node initiates the decrease checking intensity procedure. Therefore, slave nodes need to be able to discover checking intensity decreases implemented by a master node. A checking intensity decrease may be discovered in the following manner. The checking intensity decrease is discovered based on the measured usage values. As discussed above in conjunction with managing checkpoints, the method of usage measurement is different depending on whether the checkpoints are periodic or pseudo random.

In the case of pseudo random checkpoints, the node assumes that the peer has performed a decrease if the usage value μ⁽ⁱ⁾ falls below a minimum threshold μₘᵢₙ, μ⁽ⁱ⁾<μₘᵢₙ. If this condition is satisfied, the node follows the decrease by doubling the T_{(check)}⁽ⁱ⁾ parameter of the pseudo random generator, which will result in less frequent generation of checkpoints. To summarize the rules for the decrease in the pseudo random case, a node performs a checking intensity decrease if either of the two conditions are satisfied ρ_{decr}⁽ⁱ⁾<ρₘᵢₙ and/or μ⁽ⁱ⁾<μₘᵢₙ as illustrated in FIG. 10.

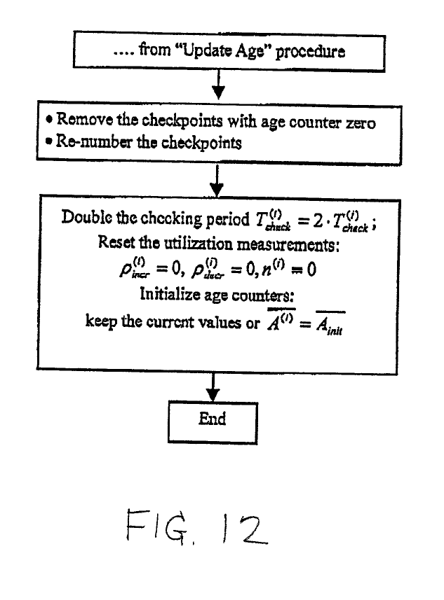

In the case of periodic checkpoints, the age counters are the usage measures of the checkpoints. Whenever the peer node that is doing the decrease does not show up at a checkpoint, the age of that checkpoint will be decreased in both nodes. The peer node misses every second alive checkpoint and depending on the offset of the decrease the missed checkpoints have a sequence number 0 or 1, assuming the checkpoints are numbered by 0 and 1. When the age counter of the missed checkpoints decreases to zero, the node assumes that the peer has increased checking period and considers the checkpoints with the respective sequence number to be dead. It doubles the checking period by keeping only the alive checkpoints and renumbers the remaining checkpoints. From that point on the two nodes have a new, increased checking period. This process can be seen in FIG. 12 which provides a flowchart depicting an exemplary “follow decrease” procedure for periodic checkpoint embodiments. Once step 1109 of FIG. 11 has been performed and the checking intensity has been decreased, the method proceeds from step 1109 to step 1111 where it ends.

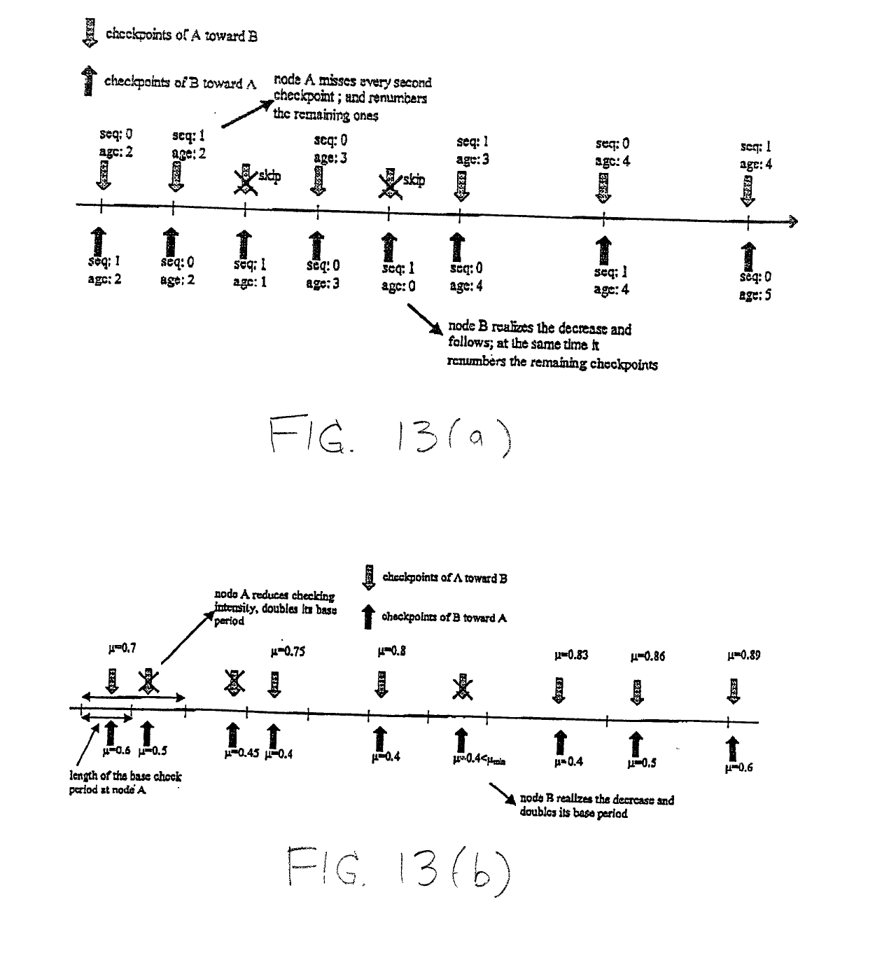

FIG. 13(a) provides an exemplary checkpoint illustration for the process of decreasing checking intensity in the case of a node pair A and B having strictly periodic checkpoints. In the example shown in the figure, it is assumed that at the beginning the nodes initially check each other at every 32^{nd} frame. Then node A decides to decrease checking intensity and starts to miss the checkpoints with sequence number 0. At the same time it renumbers the remaining checkpoints. Node B keeps checking at every alive checkpoint, but since node A does not show up at the checkpoints numbered with 1, the age of the checkpoints with sequence number 1 decreases down to zero for node B. As soon as this happens, node B will consider the checkpoints with sequence number 1 to be dead and will not check at these checkpoints in the future. Node B renumbers the remaining checkpoints and initializes the age counters. The age counter can be initialized to the age of the checkpoints that were not affected by the decrease, or to the initial value of Aᵢₙᵢₜ.

In the case of pseudo random checkpoints, nodes do not maintain age counters and sequence numbers. Instead they rely on the measured ρ_{decr}⁽ⁱ⁾ and μ⁽ⁱ⁾ values to decide about the decrease.

FIG. 13(b) provides an exemplary checkpoint illustration for the process of decreasing checking intensity in the case of a node pair A and B having pseudo random checkpoints. First, node A decreases its checking intensity by doubling the current base checking period it uses. Such a decrease may be initiated by node A, for example, because of node A measuring a low utilization.

As a consequence of node A decreasing its checking intensity, node B will find node A, on average, only at every second checkpoint. Hence, node B's measured usage will constantly decrease. Note that due to the pseudo random nature, the alternation of used and unused checkpoints generally tends not to be as systematic as it was the case with periodic checkpoints. Node B might encounter two unused consecutive checkpoints. When the measured usage μ at node B falls below the minimum μₘᵢₙ, node B realizes that the peer, node A, has lowered its checking intensity. Node B can then follow the decrease by doubling its current base period. After the decrease, node B's measured usage will start to increase.

After a checking intensity decrease, the ρ_{incr}⁽ⁱ⁾ and ρ_{decr}⁽ⁱ⁾ utilization measurements are reset. For periodic checkpoints the age counters may be reset to an initial value Aᵢₙᵢₜ. Additionally, the μ⁽ⁱ⁾ measurement may be reset.

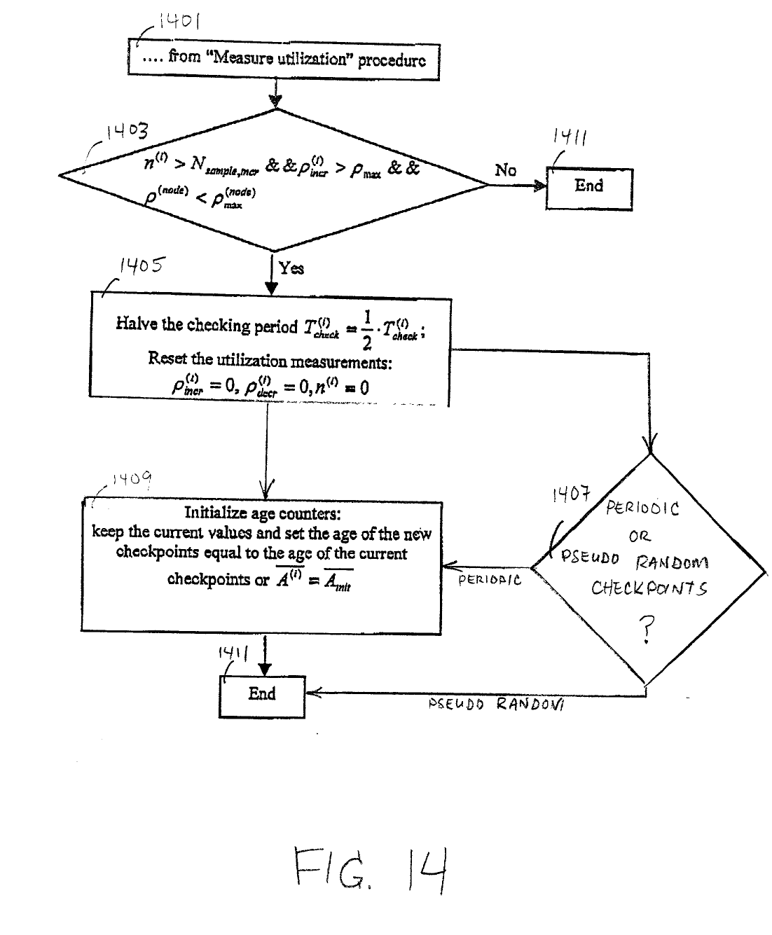

FIG. 14 is a flowchart of an exemplary method of increasing checking intensity, in accordance with the present invention. The method depicted in the figure may be used with node pairs having either periodic checkpoints or pseudo random checkpoints, the difference in keeping an age parameter being accounted for in differing branches within the method.

After a checkpoint in which user data has been exchanged (e.g., not a POLL-EMPTY packet pair) checking intensity can be increased, depending on the utilization of current checkpoints. The method of increasing checking intensity begins in step 1401, which may be entered, for example, from the measure utilization procedure. The method proceeds to step 1403 to begin the process of increasing the checking intensity.

The same events can trigger a checking intensity increase in the case of either periodic checkpoints or pseudo random checkpoints. In accordance with step 1403, a checking intensity increase may be triggered if the following conditions are satisfied: ρ_{incr}⁽ⁱ⁾>ρₘₐₓ and ρ^{node}<ρₘₐₓ^{(node)}, where ρₘₐₓ and ρₘₐₓ^{(node)} are system specific constants. According to the above conditions the checking intensity is increased if the utilization of the checkpoints on the particular link i exceeds a maximum threshold ρₘₐₓ and the node has free available capacities, that is, the absolute utilization of the node is below some maximum threshold ρₘₐₓ^{(node)}. This last condition insures that the intensity of checkpoints will not increase unbounded. If the criteria for increasing checking intensity are not met, the method proceeds in accordance with the “no” branch from step 1403 to step 1411 and ends. On the other hand, if the increase checking intensity criteria are met, the method proceeds in accordance with the “yes” branch from step 1403 to step 1405.

In regard to the process of increasing checking intensity in step 1405, it should be noted that the master and slave nodes may decide independently about the degree of the increase. The checking intensity can be increased by a factor of two, four, eight, or other value. However, it is not mandatory to increase checking intensity by any particular amount. In accordance with one embodiment, the checking intensity is doubled at one step. In step 1405 the increase is performed by dividing the current T_{(check)}⁽ⁱ⁾ parameter by a factor of two. After a checking intensity increase, the ρ_{incr}⁽ⁱ⁾ and ρ_{decr}⁽ⁱ⁾ measurements are reset, and, depending on the checkpoints are periodic or pseudo random, the age counters may be reset to an initial value Aᵢₙᵢₜ and the μ⁽ⁱ⁾ measurement have to be reset, respectively. The method proceeds from step 1405 to step 1407 where it is determined whether periodic or pseudo random checkpoints are involved. For pseudo random checkpoints, there is no need to update age counters and the method proceeds in accordance with the “pseudo random” branch from step 1407 to step 1411 where the method ends. For periodic checkpoints, the method proceeds in accordance with the “periodic” branch from step 1407 to step 1409 where the age counters are updated.

The reactiveness of the decrease procedure to missed checkpoints by a peer is controlled by the initial age in the case of periodic checkpoints, and by the moving average measurement parameters q_{usage} and N_{sample,usage} in the case of pseudo random checkpoints. These parameters may depend on the actual checking frequency and/or the amount of free resources. For example, after increasing the checking intensity to a relatively high value, the node does not tolerate the peer missing too many checkpoints. That is why the node initializes the age to a relatively low value in the case of periodic checkpoints, or sets the moving average parameters of the usage measurements to a short timescale in the case of pseudo random checkpoints. In embodiments of the present invention, the initial age may be set to a relatively small value, typically between 1 and 4. The parameter N_{sample,decr} can also be reset after the increase. If the parameter is set to a relatively small value, new checkpoints are preferably utilized even over a short timescale, otherwise the node initiates a checking intensity decrease. Similar to Aᵢₙᵢₜ, the value of N_{sample,decr} may depend on the checking frequency.

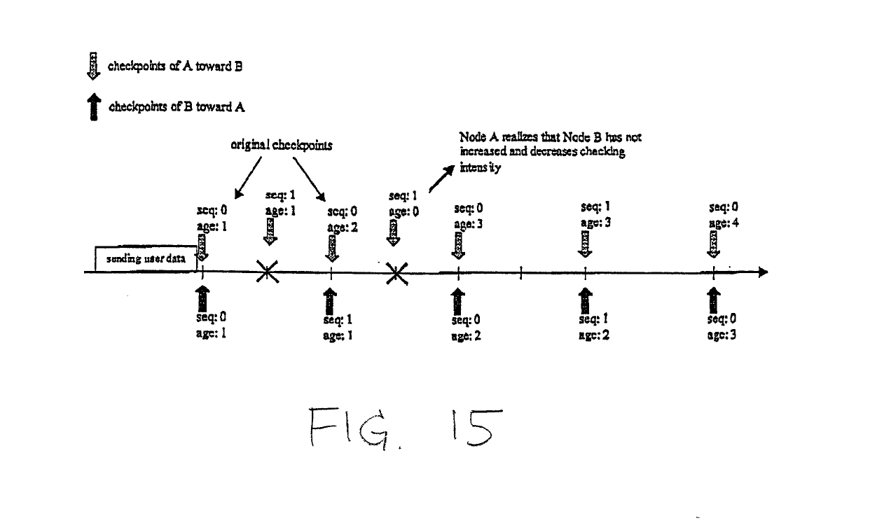

FIG. 15 depicts an example of periodic checkpoints where nodes A and B communicate, and, after exchanging user data at a checkpoint, node A doubles the checking intensity, while node B does not change it. For example, after the increase, node A initializes the age to Aᵢₙᵢₜ, which is assumed to be equal to 1 in this example. This implies that node A will start the decrease immediately if the first check is unsuccessful. That is, the increased checking intensity is supported only if the peer is doing the same right after the user data transmission. In the example, since node B has not changed checking intensity, node A will not find node B at the checkpoints with sequence number 1. Consequently, the age of the checkpoints with sequence number 1 at node A will decrease down to zero and the checkpoints will become dead. Node A decreases the checking intensity by keeping only the checkpoints with sequence number 0, and renumbering them. In this manner, the two nodes have the same checking period again.

FIG. 16 is a flowchart of an exemplary method of packet transmission/reception for node pairs having either periodic checkpoints or pseudo random checkpoints, in accordance with the present invention. The procedure of the figure describes how a node schedules transmission/reception with peer nodes, in accordance with exemplary embodiments of the present invention.

It should be noted that a node is expected to show up at all of its alive checkpoints, to send data to the given peer, and/or check whether the peer has something to send. However, both in the pseudo random and periodic checkpoint cases, collision of checkpoints can occur. Upon the occurrence of a collision, the node is forced to skip some of the checkpoints. A collision occurs if two checkpoints are scheduled exactly for the same time frames or if the checkpoints are scheduled for different time frames but these time points are so close to each other that the node can attend only one of them. For example, if two checkpoints are too close to each other a packet transmission started at the first checkpoint will necessarily overlap the second checkpoint. Furthermore, if the two checkpoints belong to links in different piconets there might be not enough time between the checkpoints to switch from one piconet to the other.

In step 1601, upon arriving at a checkpoint, a node looks ahead and checks whether the current checkpoint overlaps other upcoming checkpoints. The method proceeds to step 1603 for a determination of whether there is an ongoing communication. If there is not an existing communication, the method proceeds in accordance with the “no” branch from step 1603 to step 1609, which is discussed below. If there is an existing communication, the method proceeds in accordance with the “yes” branch from step 1603 to step 1605.

For an ongoing communication, in step 1605 the node checks whether the current communication would overlap the coming checkpoint, or checkpoints, assuming that the current communication is continued and another packet pair is exchanged. The overlapping checkpoints can be identified by having the node estimate the length of a packet exchange at the current checkpoint and checks whether there are any other checkpoints that the transmission would overlap, e.g., the length of the lookahead window preferably equals the estimated length of the packet transmission time plus some guard time if the coming checkpoint belongs to another piconet, in which case the time necessary for the switch must be also taken into account. When estimating the length of the next packet transmission the node may take into account the length of the packet at the head of its transmission buffer and assume a five frame packet from the peer as the worst case. That is, the node estimates the length of the next packet pair exchange, assuming a five frame packet response from its peer.

If the node is still far from the coming checkpoints (e.g., the number of frames until the next checkpoint is more than the expected length of the current packet pair transmission), the method proceeds in accordance with the “no” branch from step 1605 to step 1607 and the node continues the current communication. Otherwise, the method proceeds in accordance with the “yes” branch from step 1605 to step 1609 and the node makes a decision as to whether it wants to attend one of the coming checkpoints or go on with the current communication. As discussed above in conjunction with step 1603, the method can proceed to step 1609 in accordance with the “no” branch from step 1603 in the absence of an existing communication.

In step 1609, if it is determined that the coming checkpoints overlap which implies that the node cannot attend all of them. If step 1609 finds that the coming checkpoints are not colliding, the method proceeds in accordance with the “no” path to step 1613. In step 1613 the next checkpoint is the only approaching checkpoint. Therefore, step 1613 selects the node associated with the next approaching checkpoint, denoted as node j, and the method proceeds to step 1615. However, back in step 1609, if it is determined that there are colliding checkpoints, the method proceeds in accordance with the “yes” path from step 1609 to step 1611.

In step 1611, the node decides which node of the colliding checkpoints to attend. When selecting one of the overlapping checkpoints, the node can take into account one or more aspects or parameters. In one embodiment, when overlapping checkpoints occur, the selection criteria are applied in the order shown in the flowchart of the figure. For instance, the node may consider whether it has something to send to a particular peer node, whether the peer is expected to have something to send, the age of the checkpoint in the case of periodic checkpoints, or other like aspects or parameters. Of course, a node does not typically know with certainty whether or not a peer has something to send. In one embodiment, a node expects that the peer has something to send if the node had a successful check with the given peer at the last checkpoint and the last packet from the peer carried user data. If the node has not attended the last checkpoint corresponding to the given peer, the node may also expect that the peer has user data to send. FIG. 16 provides an exemplary set of selection criteria and the order in which they are examined in the transmission/reception process flowchart. Upon using the selection criteria of step 1611, or other like criteria, to select a node, the node is labeled as j and the method proceeds to step 1615. As discussed above, the method may also reach step 1615 upon completing 1613.

In step 1615 it is determined whether or not there are any current transmissions. If no current transmissions to a node are found in step 1615, the method proceeds in accordance with the “no” branch from step 1615 to step 1619. Step 1619 schedules a transmission/reception with the node j for the next corresponding checkpoint. However in step 1615, if it is determined that there are current transmissions to a node, the method proceeds in accordance with the “yes” branch from step 1615 to step 1617 to determine whether to continue the current communication or go to the checkpoint of the selected node j. In accordance with step 1617, if the selected node j satisfy selection criteria #1 and #2 (or alternatively, satisfies one of criteria #1 or #2) the method proceeds to step 1619. Otherwise, the method proceeds to step 1621. If the method proceeds to step 1619 in accordance with the “yes” branch from step 1617, the node schedules transmission/reception with the selected node j. If the method proceeds from step 1617 to step 1621 in accordance with the “no” branch, the checkpoint corresponding to the selected node j will be skipped and the current communication will be continued. In an alternative embodiment, in step 1617 an approaching checkpoint may be skipped only if it satisfies neither criteria #1 nor criteria #2, and there is an ongoing communication. In accordance with other embodiments of the present invention, various combinations of prioritizing the criteria and other selection strategies can be applied as well.

After it has been decided which checkpoint to attend in step 1617, a node may try to exchange a packet pair with given peer. In accordance with step 1621, if the packet exchange fails due to the unavailability of the peer node or for another reason, the node may skip the current communication and go to the next checkpoint.

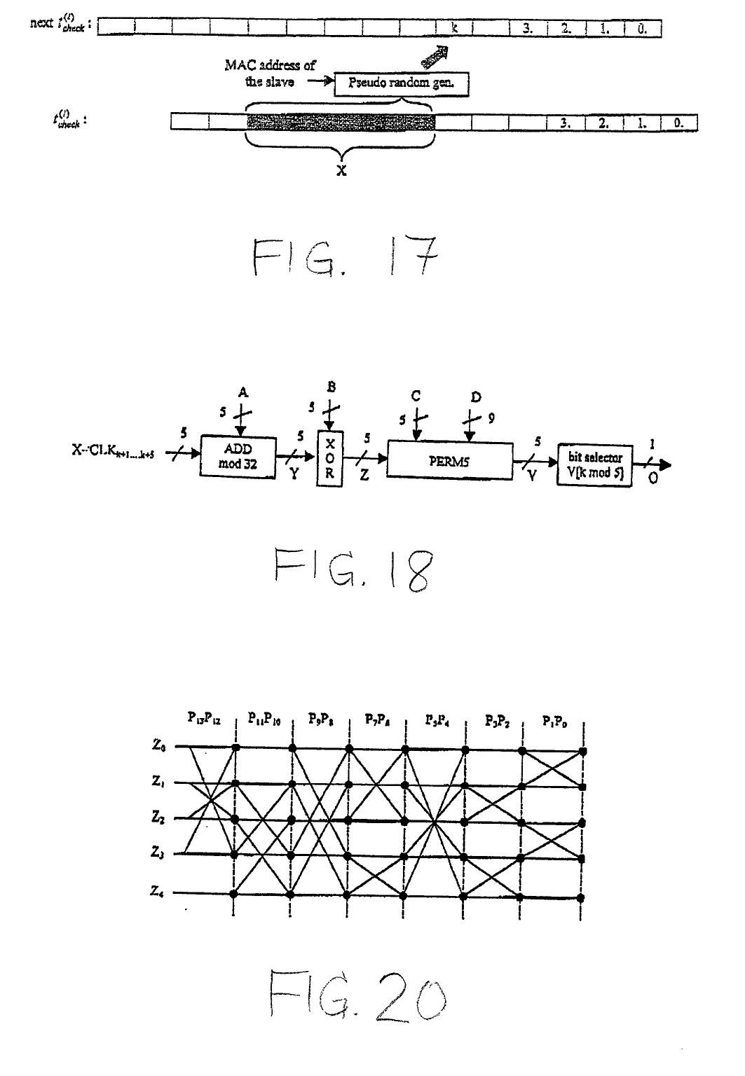

FIGS. 17-20 depict exemplary embodiments associated with generating pseudo random checkpoints which may be used in accordance with the present invention. In FIG. 17, x represents the bits, k+1 through 0+5 of the master clock which serve as an input to the pseudo random generator when generating the kth bit of the next checkpoint. The bits of the clock at the next checkpoint are generated one by one in a loop using the pseudo random generator, as depicted in FIG. 18. The Bluetooth clock of the master and the Bluetooth MAC address of the slave are inputs to the pseudo random generator.

FIG. 19 depicts a flowchart of an exemplary method of developing a pseudo random sequence for checkpoints. In step 1901 of the figure, upon arriving to a checkpoint corresponding to its ith link, a node generates the position of the next checkpoint. The variable t_{check}⁽ⁱ⁾ stores the master's clock at the time of the next checkpoint. Let us assume that the base period of the checkpoints on the ith link of the node is T_{check}⁽ⁱ⁾=2^{j-2}, j>2 number of frames. In other words, this means that on average there is one checkpoint in each time interval of length T_{check}⁽ⁱ⁾=2^{j-2} number of frames, and the jth bit of the clock changes at every T_{check}⁽ⁱ⁾.

The method proceeds to step 1903 where the position of the next checkpoint t_{check}⁽ⁱ⁾ is obtained such that the node adds T_{check}⁽ⁱ⁾ to the current t_{check}⁽ⁱ⁾, clears the bits (j−1, . . . 0) and then generates the bits (j−1, . . . 2) one by one using the pseudo random generator. The method then proceeds to step 1905 for a determination of whether k≧2. Upon determining that k is less than two, the method proceeds to step 1911 and is completed in accordance with the “no” branch from step 1905. If k≧2, the method proceeds to step 1907 in accordance with the “yes” branch from step 1905. In step 1907, when generating the kth bit, j−1≧k≧2, the clock bits t_{check}⁽ⁱ⁾[k+1, . . . , k+5] are fed as inputs to the pseudo random generator as illustrated in the figure.

The pseudo random scheme used in step 1907 for selecting the position of the next checkpoint is shown in FIG. 18. This pseudo random scheme may be derived from the frequency hop selection specified in the Bluetooth Baseband Specification 1.1 may be used in conjunction with embodiments of the present invention. The control words of the pseudo random generator of an exemplary embodiment of the present invention are listed in Table 1.

TABLE 1
Control Words

| | |
|---|---|
| A | A₂₇₋₂₃ ⊕CLK₂₅₋₂₁ |
| B | B_{0.3} = A_{22-19’} B₄ = 0 |
| C | A_{8,6,4,2,0} ⊕CLK₂₀₋₁₆ |
| D | A₁₈₋₂₀ ⊕CLK₁₅₋₇ |

These control words, e.g., A, B, C and D, are the same as the control words of the frequency hop selection scheme in the Bluetooth Baseband Specification 1.1. However, the input X and the additional bit selection operator at the end are different. As it has been discussed above the input X is changing depending on which bit of the checkpoint is going to be generated. When generating the kth bit of the checkpoint the clock bits, X=CLK_{k+1 . . . k+5} are used as inputs and the bit selection operator at the end selects the (k mod 5)th bit of the five bits long output V. Upon completing step 1907, the method proceeds to step 1909 for reduction of the k varible before looping back to step 1905 again. In step 1905, if it is determined that k is less than two, the method proceeds in accordance with the “no” branch from step 1905 to step 1911, where the method ends.

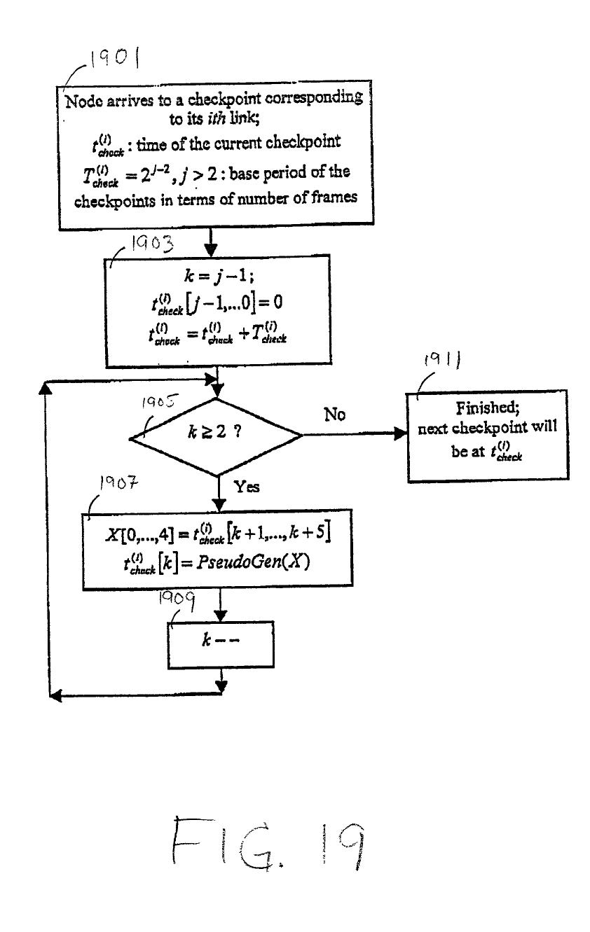

FIG. 20 depicts a butterfly permutation operation PERM5 associated with Table 2 which may be used in conjunction with exemplary embodiments of the present invention. Table 2 may be used in the PERM5 operation of the pseudo random generator depicted in FIG. 18. For example, the butterfly permutation operation PERM5 of FIG. 20 is the same as in the frequency hop selection scheme of Bluetooth Baseband Specification 1.1. The table associates each bit of the control word P with a given bit exchange in the input word.

TABLE 2
Control bits and corresponding bit exchanges

| control bit | butterfly | control bit | Butterfly |
|---|---|---|---|
| P₀ | {Z₀, Z₁} | P₇ | {Z₃, Z₄} |
| P₁ | {Z₂, Z₃} | P₈ | {Z₁, Z₄} |
| P₂ | {Z₁, Z₂} | P₉ | {Z₀, Z₃} |
| P₃ | {Z₃, Z₄} | P₁₀ | {Z₂, Z₄} |
| P₄ | {Z₀Z₄} | P₁₁ | {Z₁, Z₂} |
| P₅ | {Z₁, Z₃} | P₁₂ | {Z₀, Z₃} |
| P₆ | {Z₀, Z₂} | P₁₃ | {Z₁, Z₂} |

If the given bit of the control word is 1 the corresponding bit exchange is performed otherwise skipped. The control word P is obtained from C and D, such that P_{0 . . . 8}=D_{0 . . . 8} and Pᵢ₊₉=Cᵢ, for i=1 . . . 4.

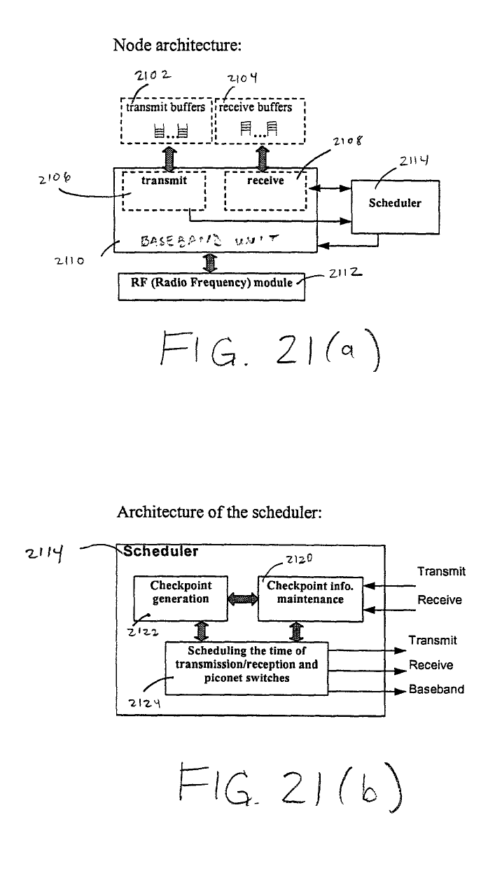

FIGS. 21(a) and 21(b) depict one exemplary hardware configuration for implementing the present invention. The various units depicted in the figures may be performed by hard-wired electrical circuits, such as ASICs (Application Specific Integrated Circuits), or by processor program instructions performed on one or more processors, or by some combination of each. Other embodiments of the invention may be comprised entirely of instructions stored in a computer readable storage medium, for execution by one or more processors to implement the methods and systems of the invention.

FIG. 21(a) is a node architecture which includes transmit buffers 2102, receive buffers 2104, transmit unit 2106, receive unit 2108, baseband unit 2110, RF module 2112 and a scheduler 2114. The transmit buffer 2102 and receive buffer 2104 store the Bluetooth packets that are going to be transmitted and that have been received, respectively. Typically, there is one such buffer per each Bluetooth link of the node. Transmit unit 2106 and receive unit 2108 may be configured as part of baseband unit 2110, as shown in the figure, or alternatively, as stand alone units.

The transmit unit 2106 provides the functions performed before sending a packet. These functions include forming the packet header, filling the header fields (e.g., address, ARQ info (Automatic Repeat Request) etc.), and fragmenting an upper layer packet into Bluetooth packets, if necessary, or other like transmit functions. The receive unit 2108 provides the functions performed upon reception of a packet. These receive functions include performing a CRC check (Cyclical Redundancy Checking) and then setting the ARQ bit in the reverse packet accordingly, reassembling the upper layer packet, or other like receive functions.

The baseband unit 2110 also provides the other baseband functions not related to packet transmission and reception. Such baseband functions include link management, Bluetooth link establishment, release; inquiry and page procedures, and other like functions. The RF module 2112 performs the modulation/demodulation and the actual transmission/reception over the radio interface. The exemplary node architecture shown FIG. 21(a) also includes a scheduler 2114, which is discussed further in conjunction with FIG. 21(b).

FIG. 21(b) is an exemplary architecture of the scheduler 2114 which includes a checkpoint generation unit 2120, a scheduling unit 2122 and a checkpoint maintenance unit 2124. The scheduling algorithm according to the present invention is implemented in the scheduler 2114. The scheduler 2114 controls the transmission and reception procedures and other baseband procedures (e.g., piconet switches). Hence, the scheduler 2114 typically is informed about new events such as, for example, the reception of new packets. To provide the scheduler 2114 with such information, the scheduler 2114 is typcially connected to the transmit unit 2106, the receive unit 2108, and the baseband unit 2110.

In one embodiment, the scheduler 2114 can be organized into three main parts, a checkpoint info maintenance unit 2120, a checkpoint generation unit 2122, a scheduling transmission/reception and piconet switches unit 2124 (scheduling T/R&PS unit 2124).

The checkpoint info maintenance unit 2120 receives notifications from transmit unit 2106 and receive unit 2108 and processes these events. For instance, the information stored about the checkpoints (e.g., utilization and usage measurements) are updated if needed in response to events from Transmit/Receive procedures. Upon processing such events the checkpoint info maintenance unit 2120 contacts the checkpoint generation unit 2122 to trigger generation of the position of the next checkpoint. The checkpoint generation unit 2122 generates checkpoints either periodically or pseudo randomly, in accordance with the present invention. Upon generating the position of the next checkpoint, the checkpoint generation unit 2120 informs the scheduling T/R&PS unit 2122 that actually schedules the new checkpoint.

The scheduling T/R&PS unit 2122 uses information received from the checkpoint info maintenance unit 2120 and the checkpoint generation unit 2122. Such information may include usage and utilization measurements of the checkpoints, and information about the checkpoint position in time. The scheduling T/R&PS unit 2122 makes decisions about the actions a node is going to take in the next coming slots (e.g., transmit a packet, receive a packet, change a piconet). The scheduling T/R&PS unit 2122 provides instructions to the baseband unit 2110, the transmit unit 2106 and the receive unit 2108, respectively.

Although the present invention has been described in connection with Bluetooth networks and protocols, it will be recognized that the present invention is applicable to all types of networks and protocols. For example, the present invention can be used in any type of network in which a node participates on a time division duplex basis between more than one network.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

1. A method of communicating between a first node and a second node in an ad hoc polling based communication infrastructure, the method comprising steps of:
defining frames for the first and the second nodes, said frames comprising checkpoints;
checking by the first node one or more of the checkpoints for presence of the second node;
adjusting a first node checking intensity in response to results of said checking step; and
communicating by transmitting a signal from said first node to said second node in accordance with the adjusted first node checking intensity.

2. The method of claim 1, wherein positions of the checkpoints are substantially periodic.

3. The method of claim 1, wherein positions of the checkpoints are pseudo randomly generated.

4. The method of claim 1, wherein the step of adjusting a first node checking intensity comprises:
increasing the first node checking intensity by changing one or more checkpoints to alive checkpoints.

5. The method of claim 1, wherein said frames are time slot pairs for communication between the first and second nodes.

6. The method of claim 5, wherein said frames each contain one or more of an offset, a time interval, usage data and utilization data for the said checkpoints.

7. The method of claim 1, wherein the step of checking comprises:
increasing a checkpoint usage value in response to both the first node and the second node being present at one of said checkpoints.

8. The method of claim 1, wherein the step of checking comprises:
decreasing a checkpoint usage value in response to either the first node or the second node not being present.

9. The method of claim 1, wherein the step of checking comprises:
increasing a checkpoint utilization value in response to a succesful data transmission at one or more of said checkpoints.

10. The method of claim 1, wherein the step of checking comprises:
decreasing a checkpoint utilization value in response to there having been no data transmission at said checkpoints.

11. The method of claim 1, wherein the step of adjusting comprises:
changing the first node checking intensity in response to a checkpoint utilization value or a checkpoint usage value.

12. The method of claim 1, wherein the step of adjusting comprises:
changing the first node checking intensity following a successful poll, the first node checking intensity being changed in response to a checkpoint usage value μ⁽ⁱ⁾ determined as follows:
μ⁽ⁱ⁾=q_{usage}×μ⁽ⁱ⁾+(1−q_{usage})×1
wherein q_{usage} is a parameter of the moving average method.

13. The method of claim 1, wherein the step of adjusting comprises:
changing the first node checking intensity following an exchange of user data, the first node checking intensity being changed in response to a checkpoint utilization value ρ⁽ⁱ⁾ determined as follows:
ρ_{incr}⁽ⁱ⁾=q_{uti,incr}×ρ_{incr}⁽ⁱ⁾+(1−q_{uti,incr})×1
ρ_{decr}⁽ⁱ⁾=q_{uti,decr}×ρ_{decr}⁽ⁱ⁾+(1−q_{uti,decr})×1
where parameters q_{uti,incr}, q_{uti,decr} determine a time scale on which the utilization value is averaged.

14. The method of claim 11, wherein the step of adjusting comprises:
increasing the first node checking intensity in response to a checkpoint utilization value or a checkpoint usage value being greater than a predetermined value.

15. The method of claim 11, wherein the step of adjusting comprises:
decreasing the first node checking intensity in response to a checkpoint utilization value or a checkpoint usage value being lower than a predetermined value.

16. The method of claim 11, wherein the step adjusting comprises:
decreasing the first node checking intensity in response to a checkpoint utilization value being lower than a predetermined value.

17. The method of claim 1, wherein the step of adjusting a first node checking intensity comprises:
decreasing the first node checking intensity by removing one or more checkpoints from among the first node checkpoints being checked.

18. The method of claim 1, wherein the second node is simultaneously a member of a first piconet and a second piconet which form a scatternet.

19. The method of claim 1, wherein the first node is a master and the second node is a slave.

20. The method of claim 19, wherein the first node actively checks for the second node by sending a packet.

21. The method of claim 22, wherein the second node passively checks the first node by listening for a packet.

23. The method of claim 1, wherein a first node checking period is T_{(check)}⁽ⁱ⁾ for an ith link of the first node.

24. The method of claim 1, further comprising steps of:
waiting to send data packets by the first node until a next checkpoint at which the second node is expected to be present; and
initiating a data transmission from the first node to the second node.

25. The method of claim 1, further comprising a step of:
increasing a first node checking intensity in response to an amount of user data to be transmitted between the first and second nodes.

26. The method of claim 1, wherein the polling based communication infrastructure is a Bluetooth system.

27. A system comprising a node in an ad hoc polling based communication infrastructure system, the node comprising:
a transmit unit for transmitting signals to other nodes;
a receive unit for receiving signals from the other nodes, said received signals comprising results of checking for presence of the other nodes;
a scheduling unit in communication with the transmit unit and the receive unit;
a checkpoint information maintenance unit in communication with the transmit unit and the receive unit; and
a checkpoint generation unit which generates checkpoints having a node checking intensity based upon the results of checking for presence of the other nodes.

28. The system of claim 27, wherein the node checking intensity is adjusted in response to the results of checking for presence of the other nodes.

29. The system of claim 27, further comprising:
a scatternet, wherein the node is simultaneously a member of a first piconet and a second piconet which form the scatternet.
